(19) United States
(12) Patent Application Publication
(10) Pub. No.: US 2008/0069617 A1
(43) Pub. Date: Mar. 20, 2008

(54) IMAGE FORMING APPARATUS, IMAGE FORMING METHOD, AND TONER FOR DEVELOPING ELECTROSTATIC IMAGE FOR USE IN THE IMAGE FORMING APPARATUS AND METHOD

(76) Inventors: Mitsuyo MATSUMOTO, Osaka (JP); Chiyoshi Nozaki, Otsu-shi (JP); Tsuyoshi Nozaki, Osaka (JP); Katsunori Kurose, Takarazuka-shi (JP); Atsushi Yamamoto, Kawanishi-shi (JP); Takuya Kadota, Kobe-shi (JP); Hiroyuki Murakami, Osaka (JP); Yoshimichi Ishikawa, Itami-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/857,175

(22) Filed: Sep. 18, 2007

(30) Foreign Application Priority Data
Sep. 19, 2006 (JP) 2006-252041
Sep. 19, 2006 (JP) 2006-252518

(51) Int. Cl. G03G 21/00

(52) U.S. Cl. 399/359

(57) ABSTRACT

To provide an image forming apparatus using a toner having inorganic fine particles externally added thereto, wherein a detached ratio R1 of the inorganic fine particles from the non-transferred toner is from 0% to 20%, a detached ratio R2 of the inorganic fine particles from toner passed through the collecting unit is from 20% to 80%, and a ratio of the detached ratio R2 to the detached ratio R1, R2/R1, is 1.5 or more.

### BACKGROUND OF THE INVENTION

1. Field of the Invention

The present invention relates to a cleanerless image forming apparatus in which toner particles remaining on a photoconductor is held once on a collecting unit such as a brush and then collected on a developing unit; to an image forming method that uses the image forming apparatus; and to a toner for developing latent electrostatic images for use in the image forming apparatus and image forming method.

2. Description of the Related Art

Image forming technologies using electrophotography, disclosed for instance in U.S. Pat. No. 227,691, Japanese Patent Application Publication (JP-B) No. 42-23910 (Japanese Patent (JP-B) No. 0528624), and Japanese Patent Application Publication (JP-B) No. 43-24748 (Japanese Patent (JP-B) No. 0594484), utilize photoconductive materials, form a latent electrostatic image on an image bearing member by various means, and produce a visible image by developing the latent electrostatic image using a toner. Alternatively, the resultant visible image is transferred to a recording medium such as paper as required and then fixed to the medium by means of heat, pressure, or solvent evaporation.

An example of a conventional technology relating to photoconductors for this type of image forming technology and image forming apparatus is disclosed in Japanese Patent Application Laid-Open (JP-A) No. 2005-043443. This publication discloses a photoconductor developed to achieve excellent wear resistance and sensitivity and capability to produce high-quality images over long periods. The photoconductor is an organic photoconductor that includes on a photoconductive support, in order, at least a charge generating layer, a first charge transfer layer, and a second charge transfer layer, wherein the first charge transfer layer contains a binder resin and a charge transfer material, the second charge transfer layer contains a modified polycarbonate resin, fluorine-containing fine resin particles, a charge transfer material and a plasticizer, and the glass transition temperature of the second charge transfer layer is from 55° C. to 65° C.

Also, JP-A No. 2004-117463 discloses an image forming apparatus developed to achieve the capability of efficient removal of materials attached to the photoconductor, in particular those materials derived from an external toner additives, and of stably produce favorable images over long periods. The disclosed image forming apparatus includes a photoconductor for bearing thereon a latent image, a charging unit configured to uniformly charge the photoconductor, an exposing unit configured to write thereon a latent image to the charged photoconductor by exposure to light based on image data, a developing unit configured to supply a toner to the latent image on the photoconductor to form a toner image, an intermediate transfer body for bearing there on the toner image transferred from the photoconductor, a transfer unit configured to transfer the toner image on the photoconductor to the intermediate transfer body, and a cleaning unit configured to clean the photoconductor after transferring. In the disclosed image forming apparatus, the intermediate transfer body has a perimeter length that is longer than the largest size of recording paper appropriate for the image forming apparatus, and includes on the surface thereof a polishing unit configured to polish a surface of the photoconductor when the surface of the intermediate transfer body has contacted the photoconductor.

Further, JP-A No. 09-015902 discloses a manufacturing method for toner for use in developing electrostatic images, which toner is capable of stably forming high-quality copied images even when the toner particles collected by a cleaning device are returned to the developing machine for second use. The disclosed method includes the steps of mixing a binder resin and a colorant in solvent that is immiscible with water; dispersing the obtained composition in an aqueous medium in the presence of hydrophilic inorganic dispersant that is coated with a carboxyl group-containing polymer and that has a BET surface area from 10 m²/g to 50 m²/g; and removing the solvent from the obtained suspension by heating and/or vacuuming.

Moreover, JP-A No. 10-111629 discloses an image forming apparatus developed for the purpose of providing an image forming apparatus capable of preventing the occurrence of image blurring and image running, wherein the image forming apparatus includes a developing unit configured to form a toner image on an image bearing member having a surface made of hard material such as amorphous silicon, a transfer unit configured to transfer the toner image onto a transfer member; and a cleaning member configured to clean the surface of the image bearing member after the toner image has been transferred. In the disclosed image forming apparatus, the cleaning member is constructed from a roller and a blade which contact the surface of the image bearing member, and the roller is an abrasive-attached roller that includes an abrasive on the surface thereof.

JP-A No. 2001-296781 discloses an image forming apparatus developed for the purpose of preventing the occurrence of filming on the image bearing member over long periods and thereby preventing image blurring and image run, wherein the surface of the image bearing member is cleaned by a cleaning member after the toner image formed on the image bearing member has been transferred, the cleaning member is constructed from an abrasive-attached cleaning blade, and the cleaning blade makes contact with the surface of the image bearing member via the abrasive. Also the surface of the image bearing member is hardened to prevent scratching by the cleaning blade.

However, these conventional techniques present various problems to be noted when toner collected from the photoconductor or transfer device is to be recycled to the developing unit. For instance, an external additive is added to the toner base particles to improve such toner characteristics as flowability and charge properties. In toner particles used for image development, however, it is preferable that the external additive be attached to the toner base so as to maintain the balance of the toner chargeability. In the transfer process, for instance, toner particles to be collected after being left on the photoconductor may be both swept up by a cleaning brush and collected by the developing unit when images are not being outputted. To achieve this, the toner should not have excessive chargeability. However, when an external additive such as silica is fixed to the toner surface to ensure flowability, the chargeability of the toner is maintained by the action of the brush or the like, and even the remaining toner after transfer sometimes retain excessive chargeability. Another problem is that an additive such as silica separates from the toner and become fixed to the surface of the photoconductor. With reducing particle size diameters, the toner surface area per unit volume increases and the amount of external additive covering the toner surface increases compared to conventional toners, and therefore, there is a tendency for the amount of external additive that becomes fixed to the surface of the photoconductor to increase.

The present invention has been accomplished in view of the above-described problems pertinent in the prior art. An object of the present invention is to provide an image forming apparatus and image forming method capable of efficiently removing materials fixed to the photoconductor while retaining chargeability of the materials and thereby stably providing favorable images over long periods, and further to provide a toner for use in this apparatus and method, without entailing an increase in the number of constituent members.

Conventionally, methods in which toner particles remaining on the latent electrostatic image bearing member after transfer are collected into a vessel for disposal by a cleaning member are widely used. In one contact cleaning method representative of the cleaning methods used, the elastic body is caused to contact the latent electrostatic image bearing member, and the toner is collected into a vessel for disposal.

However, these methods that collect toner particles remaining on the latent electrostatic image bearing member using the cleaning member fail to satisfy environmental requirements in this field due to the production of waste toner that must be disposed of. Moreover, the need to provide space for the collection vessel is more difficult to accommodate as the move to smaller sizes and smaller spaces continues.

One technology for meeting these environmental requirements is the cleanerless image forming method. In this image forming method, image recording is performed without using a device for cleaning residual toner particles after transfer. By using this cleanerless image forming method, not only is it possible to omit the cleaning device, but the residual toner particles on the latent electrostatic image bearing member can be reused during image forming. This technology is therefore extremely effective for reducing the load on the environment.

Also, since any of these cleanerless image forming methods do not involve the use of a collection vessel, they offer an advantage of reduced apparatus size. Thus it is possible to meet a requirement for small apparatus size—one of the requirements that printers and copiers using electrophotography have been required to meet. Hence, cleanerless image forming is an extremely effective technology for meeting environmental requirements and for contributing to the downsizing of image forming apparatus.

The cleanerless image forming methods are disclosed for instance JP-A Nos. 10-161400, 11-184216, 08-227253, and 08-137368.

In the methods disclosed in JP-A Nos. 10-161400 and 11-184216, however, a marked reduction is seen in the charge amount of the residual toner particles after transfer; they are either uncharged or oppositely charged. For this reason, when the toner binds to the brush charging unit, it becomes difficult to remove them. In JP-A Nos. 08-227253 and 08-137368 it is also difficult to completely make toner particles to have the same charge polarity because charging methods are adopted that are directed to make the residual toners to have an opposite polarity to the that of the original toner particles.

After toner that has been used for development are transferred from the latent electrostatic image bearing member, the charge of the toner remaining on the surface of the latent electrostatic image bearing member is markedly reduced and is uncharged or oppositely charged. For image forming apparatus/process cartridges which do not include any cleaning member, this toner is transferred to the member which charges the latent electrostatic image bearing member, and attaches to the member which charges the latent electrostatic image bearing member via a contact method. The attached toner causes charge variations when charging the latent electrostatic image.

The attached toner must be removed. Methods for removing the toner include a collection method using an image developing process and binding process in which the attached toner is bound to the latent electrostatic image bearing member by generating a potential difference between the member for charging the latent electrostatic image bearing member and the latent electrostatic image bearing member. In this method, in order to move the toner using result of the potential difference, the toner particles must be of the same polarity and the amount of toner with opposite polarity must be small. Also, in the development process, at collection the toner must be charged to at least substantially the same level as the toner before transfer and the amount of toner of opposite polarity must be small.

In one possible collection method during the development process, a potential difference is generated between the latent electrostatic image bearing member and the development roller, and the toner is collected by means of attachment to the development roller. However, when large amounts of toner of opposite polarity is present, the potential difference does not permit the toner to be collected and toner is therefore left on the latent electrostatic image bearing member. The non-transferred toner causes background smear and smears other members, thereby preventing long-lasting image stability from being obtained.

Thus, the present invention has also been accomplished in view of the foregoing problems, and an object thereof is to solve these problems by providing an image forming method and image forming apparatus with excellent image stability and durability. The device and method make use of rather than dispose of the non-transferred toner on the latent electrostatic image bearing member, prevent contamination of the member for charging the latent electrostatic image bearing member, and simplify the collection of the non-transferred toner in the development process.

### BRIEF SUMMARY OF THE INVENTION

The image forming apparatus of the present invention is an image forming apparatus including: a latent electrostatic image bearing member for bearing thereon an image; a charging unit configured to uniformly charge a surface of the latent electrostatic image bearing member; a latent electrostatic image forming unit configured to form a latent electrostatic image on the latent electrostatic image bearing member; a developing unit configured to supply a toner to the latent electrostatic image on the latent electrostatic image bearing member, for development of the image using the toner; a transfer unit configured to transfer a toner image formed on the latent electrostatic image bearing member to a transfer member; and a collecting unit configured to collect a non-transferred toner remaining on the latent electrostatic image bearing member after transfer, wherein the non-transferred toner collected by the collecting unit is supplied to the developing unit for reuse, and wherein the toner has inorganic fine particles added externally thereto, a detached ratio R1 of the inorganic fine particles from the non-transferred toner is from 0% to 20%, a detached ratio R2 of the inorganic fine particles from the toner passed through the collecting unit is from 20% to 80%, a ratio of detached ratio R2 to detached ratio R1, (R2/R1) is 1.5 or more.

In the image forming apparatus it is preferable that the charging unit function as the collecting unit.

The image forming apparatus preferably further includes a charging giving unit configured to recharge toner remaining on the surface of the latent electrostatic image bearing member after transfer, wherein when an amount of oppositely charged toner after transfer and before passing the charging unit is denoted Ra, an amount of oppositely charged toner after passing the charging unit and before passing the developing unit is denoted Rb, and an amount of oppositely charged toner before transfer and after passing the developing unit is denoted Rc, Rb<Rc and Rb/Ra<0.2.

In the image forming apparatus it is preferable that Rb/Rc≦1.

In the image forming apparatus it is preferable that the charging unit be a conductive sheet that pressure contacts the surface of the latent electrostatic image bearing member.

In the image forming apparatus it is preferable that particles of the toner be prepared using an aqueous medium.

In the image forming apparatus it is preferable that a toner composition for preparing the toner include at least a pigment, a binder resin, and a layered inorganic material with at least a portion of ions between layers modified using organic ions, and particles of the toner are prepared by dispersing and/or emulsifying in an aqueous medium at least one of an oil phase and a monomer phase, the oil phase including at least one of the toner composition and a precursor of the toner composition.

In the image forming apparatus it is preferable that the latent electrostatic image bearing member be an organic photoconductor.

In the image forming apparatus it is preferable that the cover ratio of the toner surface by the inorganic fine particles in the developing unit is from 50% to 200%.

In the image forming apparatus it is preferable that the inorganic fine particles have a volume average particle diameter of 5 nm to 200 nm.

In the image forming apparatus it is preferable that the toner have a circularity of 0.95 to 0.99 and a volume average particle diameter of 4 μm to 8 μm.

The image forming apparatus preferably further includes a fixing unit that uses a roller equipped with a heating device.

The image forming apparatus preferably further includes a fixing unit that uses a belt equipped with a heating device.

The image forming apparatus preferably further includes an oil-less fixing unit having a fixing member for which an oil coating is unnecessary.

In the image forming apparatus it is preferable that the toner be a non-magnetic single component development-use toner.

In the image forming apparatus it is preferable that the conductive sheet be formed from one selected from nylon, PTFE, PVDF and urethane.

In the image forming apparatus it is preferable that the conductive sheet has a thickness of 0.05 mm to 0.5 mm.

In the image forming apparatus it is preferable that the conductive sheet has a resistance of 10Ω to 10⁹Ω.

In the image forming apparatus it is preferable that a voltage applied to the conductive sheet be from −1.4 kV to 0 kV.

In the image forming apparatus it is preferable that the nip width of contact between the conductive sheet and the latent electrostatic image bearing member be from 1 mm to 10 mm.

In the image forming apparatus it is preferable that the layered inorganic material be a layered inorganic material in which at least part of cation that exists between layers of the layered inorganic materials is modified with organic cation.

In the image forming apparatus it is preferable that the modified layered inorganic material constitute 0.05% by mass to 2% by mass of the solid of at least one selected from the oil phase and the monomer phase.

In the image forming apparatus it is preferable that the toner have an acid value of 0.5 KOHmg/g to 40.0 KOHmg/g.

The toner of the present invention for developing a latent electrostatic image is applied to an image forming method by which non-transferred toner is temporarily collected and supplied for reuse in an image forming apparatus that includes: a latent electrostatic image bearing member for bearing thereon an image; a charging unit configured to uniformly charge a surface of the latent electrostatic image bearing member; a latent electrostatic image forming unit configured to form a latent electrostatic image on the latent electrostatic image bearing member; a developing unit configured to supply toner and develop the latent electrostatic image on the latent electrostatic image bearing member; a transfer unit configured to transfer a toner image formed on the latent electrostatic image bearing member to a transfer member; and a collecting unit configured to temporarily collect non-transferred toner remaining on the latent electrostatic image bearing member after transfer, wherein the toner has inorganic fine particles externally added thereto, a detached ratio R1 of the inorganic fine particles from the non-transferred toner is from 0% to 20%, a detached ratio R2 of the inorganic fine particles from the toner that has passed the collecting unit is from 20% to 80%, and a ratio of the detached ratio R2 to the detached ratio R1 is 1.5 or more.

An image forming method according to the present invention using an image forming apparatus includes: a latent electrostatic image bearing member for bearing thereon an image; a charging unit configured to uniformly charge a surface of the latent electrostatic image bearing member; a latent electrostatic image forming unit configured to form a latent electrostatic image on the latent electrostatic image bearing member; a developing unit configured to supply toner and develop the latent electrostatic image on the latent electrostatic image bearing member; a transfer unit configured to transfer a toner image formed on the latent electrostatic image bearing member to a transfer member; a collecting unit configured to collect non-transferred toner remaining on the latent electrostatic image bearing member after transfer, wherein the non-transferred toner collected by the collecting unit is supplied to the developing unit for reuse, the toner has inorganic fine particles externally added thereto, a detached ratio R1 of the inorganic fine particles from the non-transferred toner is from 0% to 20%, a detached ratio R2 of the inorganic fine particles from the toner that has passed the collecting unit is from 20% to 80%, and a ratio of the detached ratio R2 to the detached ratio R1 is 1.5 or more.

According to the image forming apparatus of the present invention, it is possible to provide an image forming apparatus capable of efficiently removing materials fixed to the photoconductor while maintaining the chargeability of the materials, and thereby stably forming favorable images over long periods, without entailing an increase in the number of component members.

According to the image forming method of the present invention, it is possible to efficiently remove materials fixed to the photoconductor while maintaining the chargeability of the materials and thereby stably form favorable images over long periods.

According to the electrostatic image developing toner of the present invention, it is possible to effectively prevent the occurrence of filming while maintaining chargeability. The toner according to the present invention allows optimization of the attachment state of external additives to the toner base and enables a polish cleaning action on the photoconductor by the external additives released from the toner base.

The present invention also makes it possible to provide an image forming apparatus and image forming method, both of which offer excellent image stability and durability. The apparatus and method make use of, rather than collecting and disposing of, the toner remaining on the latent electrostatic image bearing member, prevent the smearing of the member for charging the latent electrostatic image bearing member, and simplify the collection of the non-transferred toner in the development process.

### BRIEF DESCRIPTION OF THE SEVERAL VIEWS OF THE DRAWINGS

FIG. 1 shows a schematic configuration of the image forming apparatus according to the present invention.

FIG. 2 shows non-transferred toner particles remaining on the latent image bearing member and toner particles passing through a brush.

FIG. 3 is a schematic configuration of the image forming apparatus including a charging unit and a collecting unit.

FIG. 4 shows the process cartridge of the present invention.

FIG. 5 shows an example of measurements for charge distributions.

### DETAILED DESCRIPTION OF THE INVENTION

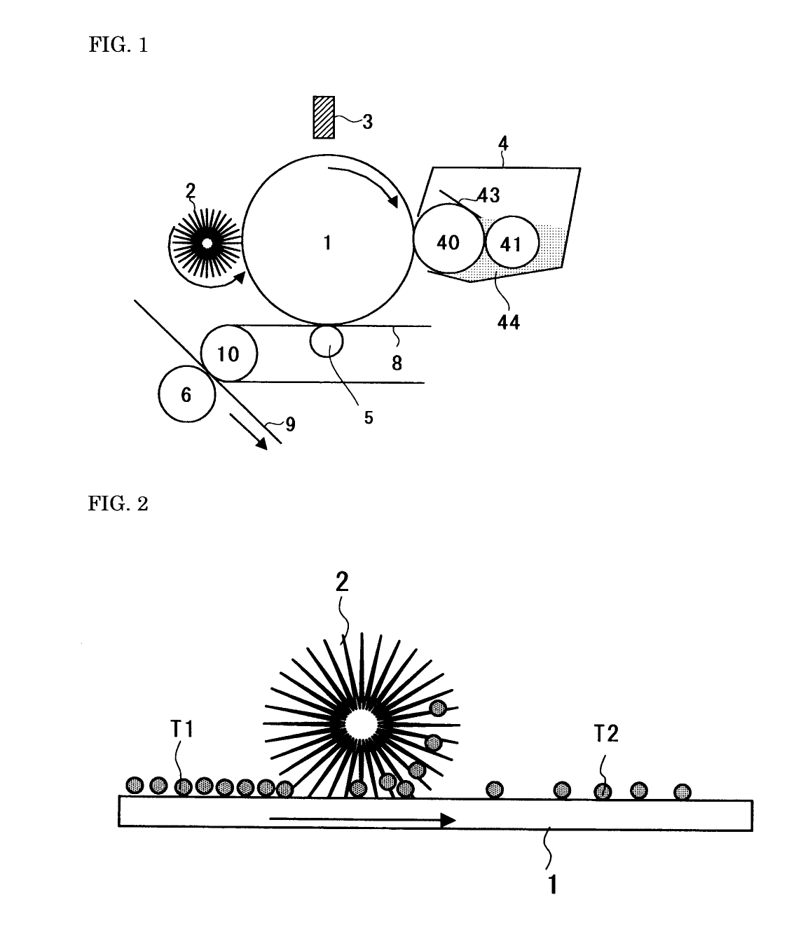

The following is a detailed description of embodiments of the present invention. FIG. 1 is a schematic view showing the configuration of the image forming apparatus according to the embodiments of the present invention. The image forming apparatus in FIG. 1 is mainly constructed from a photoconductor 1; an exposure device 3 that forms a certain latent electrostatic image on the surface of the charged photoconductor 1; a developing device 4 that forms a toner image by developing the latent electrostatic image formed by the exposure device 3; a transfer device 5 that rotates and pressure contacts with the photoconductor 1, rolls in a recording medium, and transfers the toner image to the transfer member; and, downstream of the above, a collecting/charging unit 2 that has both a collection function for collecting the toner remaining after the transfer and a charging function for charging the surface of the photoconductor to a prescribed potential uniformly. The transfer member is a concept meant to include fixing media such as transfer paper and primary and secondary intermediate transfer bodies.

The following describes operations of such an image forming apparatus. First, the collecting/charging unit 2 charges the photoconductor 2 to a prescribed potential. Next, the exposure device 3 forms a latent electrostatic image on the surface of the photoconductor 1, and the developing device 4 forms a toner image which is a visible version of the latent electrostatic image. The transfer device 5 then transfers the toner image to the recording medium, which is not shown in the drawings. The transferred toner image is then fixed to the recording medium by a fixing device 6, thereby the image is obtained. The non-transferred toner remaining on the photoconductor 1 is collected by the collecting/charging unit 2, and the photoconductor 1 is recharged for use in the next round of image forming.

In the image forming apparatus of the present embodiment, the charging unit that charges the surface of the photoconductor to a prescribed potential uniformly also functions as a collecting unit for collecting the non-transferred toner (and is denoted the collecting/charging unit below). Since the non-transferred toner collected by the developer is reused in this way, it is possible to reduce the volume of the toner cartridge or bottle and further downsize the image forming apparatus. Also, since the amount of toner that has to be disposed of can be reduced, the device also excels in terms of being environmentally friendly.

The collecting/charging unit includes a conductive fibroid brush made from such material as PET or polyamide, and is disposed so as to contact the latent image bearing member.

The latent image bearing member is preferably an organic photoconductor. An organic photoconductor is a body having an organic material as the photosensitive agent. Examples of the photosensitive agent include azo pigments and phthalocyanines and the like.

In the present embodiment, it is preferable that the image forming apparatus has a fixing unit having a roller equipped with a heating device. It is then possible to fix to the transfer member the toner image formed on the transfer member. The fixing unit having a roller equipped with a heating device may be a core with a release layer formed thereon. Examples of materials used for the core include aluminum and iron. Examples of materials used for the release layer include tetrafluoroethane, tetrafluoroethylene, silicon rubber and fluoro rubber. Note, however, that the fixing unit is not limited to being a roller and may be a belt equipped with a heating device. The belt may be a resin, rubber or metal with a release layer formed on the surface thereof. Alternatively, the fixing unit may be one that does not require an oil coating on the fixing portion.

The following describes the toner for developing the electrostatic image according to the present invention. The toner applied to the present invention is preferably a non-magnetic one component development-use toner. A non-magnetic one component development-use toner is a toner that requires no carrier and contains no magnetic components. Use of the non-magnetic single component development-use toner allows construction of a process with few parts.

<Toner Resin>

There is no particular limit on the resins used in the toner, and it can be selected for purpose. However, styrene-acryl resins and polyester resins are particularly favorable.

In the present invention polyester resins may be favorably used. However, there is no particular limit on the type of polyester resin, and any polyester resin may be used. Alternatively, a mixture including several different polyester resins may be used.

Examples of the method for producing the toner include a dissolution-suspension method which is disclosed in “Journal of the Imaging Society of Japan, Vol. 43 No. 1, 2004”, and a new polymerization method in which at least a modified polyester prepolymer and a material containing a toner composition is dissolved and dispersed in an organic solvent, and the solution or the dispersion is cross-linked and/or elongated in an aqueous medium, and then the solvent is removed from the obtained dispersion to yield a toner. The polymerization method for producing the toner is preferably applied in which at least a polyester, which may contain a modified polyester prepolymer as a binder resin, and a material containing a toner composition and/or a radical generator are dissolved and dispersed in an organic solvent, the solution or dispersion thereof, which are also referred to as an oil phase, is emulsified or dispersed in the presence of a radical generator in an aqueous medium, and the solvent is removed therefrom, thereby obtaining a toner.

The polymerization method for producing the toner will be precisely explained hereinafter.

[Material for Oil Phase]

(Polyester)

Binder resins for use in the present invention are polyesters which contain no vinyl polymer groups. Examples of such polyesters include known polyesters, such as an unmodified polyester obtained from the reaction of polycarboxylic acid and polyol, and so-called modified polyester obtained from a polyester prepolymers having an isocyanate group. These may be used alone or in combination.

(Modified Polyester)

In the present invention, a polyester prepolymer having an isocyanate group (A) may be used for forming a modified polyester. The polyester prepolymer (A) is formed from a reaction between polyester having an active hydrogen group formed by polycondensation between polyol (1) and a polycarboxylic acid (2), and a further reaction with polyisocyanate (3). Examples of active hydrogen groups contained in the polyester include a hydroxyl group such as an alcoholic hydroxyl group and a phenolic hydroxyl group; an amino group; a carboxylic group; and a mercapto group. Among these, the alcoholic hydroxyl group is preferable.

(Polyols)

Examples of the polyols (1) include alkylene glycols such as ethylene glycol, 1,2-propylene glycol, 1,3-propylene glycol, 1,4-butanediol and 1,6-hexanediol; alkylene ether glycols such as diethylene glycol, triethylene glycol, dipropylene glycol, polyethylene glycol, polypropylene glycol and polytetramethylene ether glycol; alicyclic diols such as 1,4-cyclohexane dimethanol and hydrogenated bisphenol A; bisphenols such as bisphenol A, bisphenol F, bisphenol S, and 4,4′-dihydroxybiphenyls such as 3,3′-difluoro-4,4′-dihydroxybiphenyl; bis(hydroxyphenyl)alkanes such as bis(3-fluoro-4-hydroxyphenyl)methane, 1-phenyl-1,1-bis(3-fluoro-4-hydroxyphenyl)ethane, 2,2-bis(3-fluoro-4-hydroxyphenyl)propane, 2,2-bis(3,5-difluoro-4-hydroxyphenyl)propane (also known as tetrafluorobisphenol A), 2,2-bis(3-hydroxyphenyl)-1,1,1,3,3,3-hexafluoro propanes; bis(4-hydroxyphenyl)ethers such as bis(3-fluoro-4-hydroxyphenyl)ether; an adduct of an alkylene oxide of the aliphatic diol such as ethylene oxide, propylene oxide and butylene oxide; and an adduct of the bisphenols of an alkylene oxide such as ethylene oxide, propylene oxide and butylene oxide.

Among these, the alkylene glycol having 2 to 12 carbon atoms, and the alkylene oxide adduct of the bisphenols are preferable. The alkylene oxide adduct of the bisphenols, and the combination of the alkylene oxide adduct of the bisphenols and the alkylene glycol having 2 to 12 carbon atoms are particularly preferable.

In addition, examples thereof include polyvalent aliphatic alcohols having three to eight valences or more such as glycerin, trimethylolethane, trimethylolpropane, pentaerythritol and sorbitol; phenols having three or more valences such as trisphenol PA, phenol novolac and cresol novolac; and an alkylene oxide adduct of the polyphenols having three or more valences.

The polyols can be used alone or in combination, and are not limited to the above examples.

(Polycarboxylic Acids)

Examples of the polycarboxylic acids (2) include alkylene dicarboxylic acids such as succinic acid, adipic acid and sebacic acid; alkenylene dicarboxylic acids such as maleic acid and fumaric acid; and aromatic dicarboxylic acids such as phthalic acid, isophthalic acid, terephthalic acid and naphthalenedicarboxylic acid, 3-fluoro isophthalate, 2-fluoro isophthalate, 2-fluoro terephthalate, 2,4,5,6-tetrafluoro isophthalate, 2,3,5,6-tetrafluoro terephthalate, 5-trifluoromethyl isophthalate, 2,2-bis(4-carboxyphenyl)hexafluoropropane, 2,2-bis(3-carboxyphenyl) hexafluoropropane, 2,2′-bis(trifluoromethyl)-4,4′-biphenyldicarboxylate, 3,3′-bis(trifluoromethyl)-4,4′-biphenyldicarboxylate, 2,2′-bis(trifluoromethyl)-3,3′-biphenyldicarboxylate, and hexafluoroisopropylidene diphthalic anhydride. Among these, the alkenylene dicarboxylic acid having 4 to 20 carbon atoms and the aromatic dicarboxylic acid having 8 to 20 carbon atoms are preferable. Examples of the polycarboxylic acids with three or more valences include an aromatic polycarboxylic acid having 9 to 20 carbon atoms of such as trimellitic acid and pyromellitic acid. An anhydrides of the above-mentioned compounds or lower alkylesters such as methyl ester, ethyl ester and isopropyl ester may be used to react with the polyol (1). Polycarboxylic acids can be used alone or in combination, and are not limited to the above examples.

(Ratio of Polyol to Polycarboxylic Acid)

The ratio of the polyol (1) to the polycarboxylic acid (2) is, defined to be an equivalent ratio [OH]/[COOH] of a hydroxyl group [OH] to a carboxyl group [COOH], usually 2/1 to 1/1, preferably 1.5/1 to 1/1, and more preferably 1.3/1 to 1.02/1.

(Polyisocyanates)

Examples of the polyisocyanates (3) include aliphatic polyisocyanates such as tetramethylene diisocyanate, hexamethylene diisocyanate, and 2,6-diisocyanato methyl caproate; alicyclic polyisocyanates such as isophorone diisocyanate, and cyclohexyl methane diisocyanate; aromatic diisocyanates such as tolylene diisocyanate and diphenylmethane diisocyanate; aromatic-aliphatic diisocyanates such as α,α,α′,α′-tetramethylxylene diisocyanate; isocyanurates; the polyisocyanate blocked by phenol derivative, oxime and caprolactam; and a combination thereof.

(Ratio of Isocyanate Group to Hydroxyl Group)

The ratio of the polyisocyanate (3) is, defined to be an equivalent ratio [NCO]/[OH] of an isocyanate [NCO] to a hydroxyl group [OH] of the polyester having a hydroxyl group, usually 5/1 to 1/1, preferably 4/1 to 1.2/1, and more preferably 2.5/1 to 1.5/1. When the ratio of [NCO]/[OH] is more than 5, the low-temperature fixing property becomes poor. When the molar ratio of [NCO] is less than 1, the urea content in the modified polyester decreases, and the hot-offset resistance degrades. The content of the polyisocyanate (3) component in the polyester prepolymer having an isocyanate group at its end (A) is usually 0.5% by mass to 40% by mass, preferably 1% by mass to 30% by mass, and more preferably 2% by mass to 20% by mass. When the content is less than 0.5% by mass, the hot-offset resistance decreases, and it is disadvantageous in terms of the compatibility between the heat-resistant storage stability and the low-temperature fixing property. When it is more than 40% by mass, the low-temperature fixing property decreases.

(The Number of Isocyanate Groups in Polyester Prepolymer)

The number of isocyanate group included in one molecule of polyester prepolymer having an isocyanate group (A) is usually one or more, preferably 1.5 to 3 on average, and more preferably 1.8 to 2.5 on average. When it is less than one per molecule, the molecular mass of the modified polyester is reduced after cross-linking/elongation, and then the hot-offset resistance decreases.

(Cross-Linking Agent and Elongating Agent)

In the present invention, amines may be used as a cross-linking agent and/or elongating agent. Examples of the amines (B) include a diamine compound (B1), a polyamine compound having three or more valences (B2), an amino alcohol (B3), an amino mercaptan (B4), an amino acid (B5) and a component in which an amino group of B1 to B5 is blocked (B6). The diamine compound (B1) include aromatic diamines such as phenylene diamine, diethyltoluene diamine, 4,4′-diaminodiphenylmethane, and tetrafluoro-p-xylenediamine, tetrafluoro-p-phenylenediamine; alicyclic diamines such as 4,4′-diamino-3,3′-dimethyldicyclohexylmethane, diamine cyclohexane and isophorone diamine; and aliphatic diamines such as ethylene diamine, tetramethylene diamine, hexamethylene diamine, dodecafluoro hexylene diamine and tetracosafluoro dodecylenediamine.

Examples of the polyamine compounds having three or more valences (B2) include diethylenetriamine and triethylenetetramine. Examples of the amino alcohols (B3) include ethanolamine, diethanolamine and hydroxyethylaniline. Examples of the amino mercaptans (B4) include an aminomethyl mercaptan and aminopropyl mercaptan.

Examples of the amino acids (B5) include aminopropionic acid and aminocaproic acid. Examples of the components in which an amino group of B1 to B5 is blocked (B6) include a ketimine compound obtained from the amines B1 to B5 and ketones such as acetone, methyl ethyl ketone and methyl isobutyl ketone; and an oxazolidine compound. Among these amines (B), B1 and a mixture of B1 with a small amount of B2 are preferable.

(Terminator)

A terminator may be optionally used for cross-linking and/or elongation to adjust the molecular mass of the modified polyester after terminating the reaction. Examples of the terminators include monoamines such as diethylamine, dibutylamine, butylamine and laurylamine; and a ketimine compound that the amine functionalities thereof are blocked.

(Ratio of Amino Group to Isocyanate Group)

The ratio of the amines (B) is, defined to be an equivalent ratio [NCO]/[NHₓ] of an isocyanate [NCO] in the polyester prepolymer having an isocyanate group (A) to an amino group [NHₓ] in the amines (B), usually 1/2 to 2/1, preferably 1.5/1 to 1/1.5, and more preferably 1.2/1 to 1/1.2. When the ratio of [NCO]/[NHₓ] is more than 2 or less than ½, the molecular mass of the urea-modified polyester decreases, and the hot-offset resistance decreases.

(Unmodified Polyester)

In the present invention, not only using a modified polyester alone as a binder resin, it is also important that an unmodified polyester (C) be included together with the modified polyester (A) as a binder resin. When the modified polyester (A) is used in combination with the unmodified polyester (C), the low-temperature fixing property and gloss property when used in a full-color device is improved. Examples of the unmodified polyester (C) include a polycondensation product of a polyol (1) and a polyvalent carboxylic acid (2), and the like, which is the same as the polyester component of the modified polyester (A). Preferable compounds thereof are also the same as the unmodified polyester (C). As for the unmodified polyester (C), in addition to an unmodified polyester, it may be a polymer which is modified by a chemical bond other than an urea bond, for example, it may be modified by a urethane bond. It is preferable that at least a part of the modified polyester (A) is compatible with a part of the unmodified polyester (C), from the aspect of the low-temperature fixing property and hot-offset resistance. Thus, it is preferable that the composition of the modified polyester (A) be similar to that of the unmodified polyester (C). When the modified polyester (A) is included, the mass ratio of the modified polyester (a) to the unmodified polyester (C) is usually 5/95 to 75/25, preferably 10/90 to 25/75, and more preferably 12/88 to 25/75, and still more preferably 12/88 to 22/78. When the mass ratio of the modified polyester (A) is less than 5%, it makes hot-offset resistance lower and brings disadvantages in compatibility between heat-resistant storage stability and low-temperature fixing property.

(Molecular Mass of Unmodified Polyester)

The molecular mass peak of the unmodified polyester (C) is usually 1,000 to 30,000, preferably 1,500 to 10,000, and more preferably 2,000 to 8,000. When it is less than 1,000, the hot-offset resistance is decreased. When it is more than 10,000, the low-temperature fixing property is decreased. The hydroxyl value of the unmodified polyester (C) is preferably 5 mg KOH/g or greater, more preferably 10 KOH/g to 120 KOH/g, and still most preferably 20 KOH/g to 80 KOH/g. When it is less than 5 KOH/g, it is disadvantageous in terms of the compatibility between the heat-resistant storage stability and the low-temperature fixing property. The acid value of the unmodified polyester (C) is usually 0.5 mg KOH/g to 40 mg KOH/g, and preferably 5 mg KOH/g to 35 mg KOH/g. The unmodified polyester tends to be a negative electric property by having an acid value. Each of the acid value and hydroxyl value of the unmodified polyester which exceeds this range may be easily influenced by the environment, and an image may be easily degraded either under high temperature and high humidity, or low temperature and low humidity.

(Colorant)

The colorant is not particularly limited and may be appropriately selected from known dyes and pigments. Examples thereof include carbon black, nigrosine dyes, iron black, Naphthol Yellow S, Hansa Yellow (10G, 5G, G), Cadmium Yellow, Yellow Iron Oxide, Yellow Ocher, Chrome Yellow, Titan Yellow, Polyazo Yellow, Oil Yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, Anthracene Yellow BGL, Isoindolinone Yellow, Colcothar, Red Lead Oxide, Lead Red, Cadmium Red, Cadmium Mercury Red, Antimony Red, Permanent Red 4R, Para Red, Fire Red, Parachlororthonitroaniline Red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, eosine lake, Rhodamine Lake B, Rhodamine Lake Y, Alizarine Lake, Thioindigo Red B, Thioindigo Maroon, Oil Red, Quinacridone Red, Pyrazolone Red, Polyazo Red, Chrome Vermilion, Benzidine Orange, Perynone Orange, Oil Orange, Cobalt Blue, Cerulean Blue, Alkali Blue Lake, Peacock Blue Lake, Victoria Blue Lake, metal-free Phthalocyanine Blue, Phthalocyanine Blue, Fast Sky Blue, Indanthrene Blue (RS, BC), Indigo, Ultramarine, Prussian Blue, Anthraquinone Blue, Fast Violet B, Methyl Violet Lake, Cobalt Violet, Manganese Violet, Dioxazine Vviolet, Anthraquinone Violet, Chrome Green, Zinc Green, Chromium Oxide, Viridian, Emerald Green, Pigment Green B, Naphthol Green B, Green Gold, Acid Green Lake, Malachite Green Lake, Phthalocyanine Green, Anthraquinone Green, Titanium Oxide, Zinc White, Lithopone and a combination thereof.

The amount of the colorant in the toner is usually 0.1 mass % to 15 mass %, and preferably 3 mass % to 10 mass %.

(Formulation of Colorant into Master Batch)

The colorant may be used as a master batch in a composite with a resin as well. Examples of the binder resins melt-kneaded with producing masterbatch or masterbatch, other than the modified and unmodified polyester, include styrenes and polymers of the substitution product thereof such as polystyrene, poly(p-chlorostyrene) and polyvinyltoluene; styrene copolymers such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-α-chloromethyl methacrylate copolymer, styrene-acrylonitrile copolymer, styrene-vinyl methyl ketone copolymer, styrene-butadiene copolymer, styrene-isoprene copolymer, and styrene-acrylonitrile-indene copolymer, styrene-maleic acid copolymer, styrene-maleate copolymer; polymethylmethacrylate, polybutylmethacrylate, polyvinyl chloride, polyvinyl acetate, polyethylene, polypropylene, polyester, an epoxy resin, an epoxy polyol resin, polyurethane, polyamide, polyvinyl butyral, a polyacrylic acid resin, rosin, modified rosin, terpene, an aliphatic or alicyclic hydrocarbon resin, an aromatic petroleum resin, chlorinated paraffin and paraffin wax. These may be used alone or in combination.

(Method for Producing Master Batch)

The master batch can be produced by mixing and kneading the resin and colorant for a master batch under high shear force. An organic solvent may be added to increase interaction between the colorant and the resin. A flushing method is preferably used to produce the master batch, because a wet cake of the colorant can be used directly without drying. The flushing method may be used in which an aqueous paste containing water and a colorant is mixed and kneaded together with the resin and the organic solvent so that the colorant approaches to the resin and then the water and the organic solvent are removed thereafter. For the mixing and kneading, a high shear dispersing machine such as a three roller mill, or the like may be preferably used. In addition, the master batch may be prepared and used as a dispersion and solution (wet master) for the organic solvent for the oil phase to enhance the dispersibility and solubility to the solvent when forming the oil phase.

(Wax)

The toner contains a wax as a releasing agent together with the binder resin and the colorant. Any known wax may be used, for example, those described in “Properties and application of wax Revised 2nd edition”, supervised by Kenzo Fusegawa, Saiwai shobo can be used. Examples of the wax include polyolefins such as polyethylene wax and polypropylene wax; paraffins such as paraffin wax, SASOL wax; synthetic esters such as trimethylolpropane tribehenate, pentaerythritol tetrabehenate, pentaerythritol diacetate dibehenate, glycerin tribehenate and 1,18-octadecanediol distearate, tristearyl trimellitate, distearyl maleate, octadecyl stearate; natural plant waxes such as carnauba wax, rice wax, candelilla wax; natural mineral waxes such as montan wax, ozokerite, ceresin; synthetic waxes of fatty acid amide such as stearic acid amide.

Among these, the polyolefins, the paraffins, the synthetic esters, the carnauba wax and the rice wax are preferable, and may be used alone or in combination.

The amount of the wax in the toner is 2 parts by mass to 30 parts by mass, and preferably 4 parts by mass to 15 parts by mass based on 100 parts by mass of the resin. When the amount of the wax is less than 4 parts by mass, the wax is exuded on the surface of the fixing member so as not to adhere to the fixing member when fixing, however, the releasing property is not effective enough depending on the kinds of wax due to the small amount of the wax, thus the hot-offset margin may be lost. On the other hand, when the amount of the wax is more than 15 parts by mass, the wax is easily suffered from the effect of heat energy and mechanical energy, as the wax melts at low temperature. When the low-melting point wax is used, for example, in a two-component toner, the wax may be detach from the toner surface during stirring with the carrier in a developing portion, and attached to a toner control member and a photoconductor, thereby generating an image noise. When it is used in a one-component toner, the wax may be attached to a blade in a developing control portion, thereby generating an image noise.

The endothermic peak of the wax upon temperature rising measured by a differential scanning calorimeter (DSC) is preferably 65° C. to 115° C. and the toner can be fixed at low temperature. When the melting point is less than 65° C., the flowability may be decreased. When the melting point is more than 115° C., the fixing property tends to be decreased.

(Organic Solvent for Oil Phase)

The toner of the invention is prepared as follows: the toner composition containing at least the polyester as a binder resin, the colorant, and the wax is dissolved or dispersed into an organic solvent, and the dissolved or dispersed substance is emulsified or dispersed in an aqueous medium in the presence of a radical generator with an inorganic dispersing agent or resin fine particles, and then the solvent is removed. The polyester as the binder resin does not contain vinyl polymer group.

The organic solvent which dissolves or disperses the toner composition containing the polyester as a binder resin, the colorant, and the wax has preferably a Hansen solubility parameters of 19.5 or less, for example, the organic solvent described in “POLYMER HANDBOOK” 4th Edition, Volume 2, Section VII, WILEY-INTERSCIENCE. In addition, it is more preferably volatile and has a boiling point of lower than 150° C. in terms of easy removal of solvent afterward.

Examples of the organic solvents include hexane, cyclohexane, toluene, xylene, benzene, carbon tetrachloride, 1,1-dichloroethane, 1,1,1-trichloroethane, trichloroethylene, chloroform, methyl acetate, ethyl acetate, butyl acetate, methyl ethyl ketone, and tetrahydrofuran. These are used alone or in combination.

Particularly preferable are esters such as methyl acetate, and ethyl acetate; aromatic solvents such as toluene and xylene; and halogenated hydrocarbons such as methylene chloride, 1,2-dichloroethane, chloroform and carbon tetrachloride. The polyester resin, the colorant and the releasing agent may be dissolved or dispersed simultaneously. Generally, each is dissolved or dispersed independently. The organic solvent used may be different or the same for each of the polyester resin, the colorant, but use of the same solvent is preferable from the point of view of the subsequent processing of the solvent.

Material for Aqueous Medium

(Aqueous Medium)

The aqueous medium may be water alone, alternatively the aqueous medium may be used with a solvent which can be mixed with water. Examples of the solvents mixable with water include alcohol such as methanol, isopropanol, and ethylene glycol; dimethylformamide; tetrahydrofuran; cellosolves such as methyl cellosolve; and a lower ketone such as acetone and methyl ethyl ketone. The organic solvent having a Hansen solubility parameters of 19.5 or less, which is described in the oil phase, may be mixed. When the amount to be added thereof is near water saturation, it preferably facilitates the emulsification of the oil phase and enhances the dispersion stability. The amount of the aqueous medium is preferably 50 parts by mass to 2,000 parts by mass, more preferably 100 parts by mass to 1,000 parts by mass based on 100 parts by mass of the toner composition. When the amount is less than 50 parts by mass, the toner composition is dispersed insufficiently within the aqueous medium, thus the toner particles having a predetermined particle diameter cannot be obtained. When the amount is more than 20,000 parts by mass, it is not economical. The radical generators added to an aqueous medium is not limited as long as they are water dispersible or water soluble, and may be used alone or in combination. In addition, a combination of an oxidizing agent and a reducing agent may be used for taking advantage of an oxidation-reduction reaction. The amount to be added thereof is adjusted depending on the kinds of the radical generator and the granulation temperature based on the solid content of the toner. It is 0.1 mass % to 20 mass %, and preferably 0.5 mass % to 10 mass %.

(Radical Generator)

The radical generator, known as a polymerization initiator, can be used. For example, it is the radical generator described in “POLYMER HANDBOOK” 4th Edition, Volume 1, Section II, WILEY-INTERSCIENCE. The radical generator may be added to the oil phase and/or water phase. When added to the oil phase, the oil-soluble polymerization initiator is preferably used. When added to the aqueous phase, the water-soluble polymerization initiator is preferably used.

Examples of the oil-soluble polymerization initiators include azo-based or diazo-based polymerization initiators such as 2,2′-azobis (2,4-dimethylvaleronitrile), 2,2′-azobisisobutylonitrile, 1,1′-azobis (cyclohexane-1-carbonitrile), 2,2′-azobis-4-methoxy-2,4-dimethylvaleronitrile, azobisisobutyronitrile; peroxide-based polymerization initiators such as benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butyl peroxycyclohexyl)propane, tris-(t-butylperoxy)triazine; and a polymerization initiator having peroxide at its side chain.

The water-soluble polymerization initiators include persulfates such as potassium persulfate, ammonium persulfate, 2,2′-azobis(2-methylpropionic amidine dihydrochloride), 2,2-azobis[N-(2-carboxyethyl)-2-methylpropionic amidine], 4,4′-azobis(4-cyanovaleric acid) azobisamino dipropane acetate, azobiscyano valeric acid and salt thereof, and hydrogen peroxide.

(Inorganic Dispersing Agent)

The dissolved and dispersed substances of the toner composition are dispersed in the aqueous medium in the presence of the inorganic dispersing agent or resin fine particles. Examples of the inorganic dispersing agents include tricalcium phosphate, calcium carbonate, titanium oxide, colloidal silica, and hydroxyapatite. It is preferable to use the dispersing agent, because the toner may have the sharp particle diameter distribution and be dispersed stably.

(Resin Fine Particles)

It is preferable to add resin fine particles to the toner of the invention. Any resin may be used as a resin which forms resin fine particles, as long as the resin can form an aqueous dispersion. It may be either thermoplastic or thermoset, and examples thereof include vinyl resins, polyurethane resins, epoxy resins, polyester resins, polyamide resins, polyimide resins, silicone resins, phenol resins, melamine resins, urea resins, aniline resins, ionomer resins, and polycarbonate resins. These resins may be used in combination. Among these, vinyl resins, polyurethane resins, epoxy resins, polyester resins and combination thereof are preferable from the viewpoint that an aqueous dispersion of microfine spherical resin particles can be easily obtained.

(Vinyl Resin)

A vinyl resin is a polymer which is formed by polymerizing or copolymerizing of a vinyl monomer. Examples of vinyl monomers are the following (1) to (10) compounds.

(1) Vinyl hydrocarbons:

Aliphatic vinyl hydrocarbons: alkenes such as ethylene, propylene, butene, isobutylene, pentene, heptene, diisobutylene, octene, dodecene, octadecene, and other α-olefins; alkadienes such as butadiene, isoprene, 1,4-pentadiene, 1,6-hexadiene, 1,7-octadiene and the like.

Alicyclic vinyl hydrocarbons: mono- or di-cyclo-alkenes and alkadienes such as cyclohexene, (di)cyclopentadiene, vinylcyclohexene, ethylidenebicycloheptene, and the like; terpenes such as pinene, limonene, indene, and the like.

Aromatic vinyl hydrocarbons: styrene and hydrocarbyl (alkyl, cycloalkyl, aralkyl and/or alkenyl)-substituted styrene, for example, α-methylstyrene, vinyltoluene, 2,4-dimethylstyrene, ethylstyrene, isopropylstyrene, butylstyrene, phenylstyrene, cyclohexylstyrene, benzylstyrene, crotylbenzene, divinylbenzene, divinyltoluene, divinylxylene, trivinylbenzene, and the like; and vinylnaphthalene.

(2) Carboxyl group-containing vinyl monomers and salts thereof: unsaturated monocarboxylic acids and unsaturated dicarboxylic acids having 3 to 30 carbon atoms, and their anhydrides and monoalkyl (1 to 24 carbon atoms) esters, such as (meth)acrylic acids, maleic acid (anhydride), maleic acid monoalkyl esters, fumaric acid, fumaric acid monoalkyl esters, crotonic acid, itaconic acid, itaconic acid monoalkyl esters, itaconic acid glycol monoesters, citraconic acid, citraconic acid monoalkyl esters, cinnamic acid, and the like.

(3) Sulfonic acid group-containing vinyl monomers and vinyl sulfuric acid monoester compounds and salts thereof: alkenesulfonic acids having 2 to 14 carbon atoms, such as vinylsulfonic acid, (meth)allylsulfonic acid, methylvinylsulfonic acid, and styrenesulfonic acid; and alkyl (2 to 24 carbon atoms) derivatives thereof, such as α-methylstyrenesulfonic acid and the like; sulfo(hydroxy)alkyl-(meth)acrylate or -(meth)acrylamides, for example, sulfopropyl(meth)acrylate, 2-hydroxy-3-(meth)acryloyloxypropylsulfonic acid, 2-(meth)acryloylamino-2,2-dimethylethanesulfonic acid, 2-(meth)acryloyloxyethanesulfonic acid, 3-(meth)acryloyloxy-2-hydroxypropanesulfonic acid, 2-(meth)acrylamido-2-methylpropanesulfonic acid, 3-(meth)acrylamido-2-hydroxypropanesulfonic acid, alkyl (3 to 18 carbon atoms) allylsulfosuccinic acid, poly(n=2 to 30)oxyalkylene (ethylene, propylene, butylene; homo, random or block) mono(meth)acrylate sulfate [poly(n=5 to 15)oxypropylene monomethacrylate sulfate etc.], polyoxyethylene polycyclic phenyl ether sulfate.

(4) Phosphoric acid group-containing vinyl monomers and salts thereof:

phosphoric acid (meth)acryloyloxyalkyl monoesters, such as 2-hydroxyethyl(meth)acryloylphosphate, phenyl-2-acryloyloxyethyl phosphate and (meth)acryloyloxyalkyl (1 to 24 carbon atoms) phosphonates such as 2-acryloyloxyethyl phosphonate, and salts thereof.

The salts of the above compounds (2) to (4) include the corresponding alkali metal salts (such as sodium salts, potassium salts), alkaline earth metal salts (such as calcium salts, magnesium salts), ammonium salts, amine salts, and quaternary ammonium salts.

(5) Hydroxyl Group-Containing Vinyl Monomers:

hydroxystyrene, N-methylol(meth)acrylamide, hydroxyethyl(meth)acrylate, hydroxypropyl(meth)acrylate, polyethylene glycol mono(meth)acrylate, (meth)allyl alcohol, crotyl alcohol, isocrotyl alcohol, 1-buten-3-ol, 2-buten-1-ol, 2-butene-1,4-diol, propargyl alcohol, 2-hydroxyethyl propenyl ether, sucrose allyl ether, and the like.

(6) Nitrogen-containing vinyl monomers:

Amino group-containing vinyl monomers: aminoethyl (meth)acrylate, dimethylaminoethyl (meth)acrylate, diethylaminoethyl (meth)acrylate, t-butylaminoethyl methacrylates, N-aminoethyl(meth)acrylamide, (meth)allylamine, morpholinoethyl (meth)acrylate, 4-vinylpyridine, 2-vinylpyridine, crotylamine, N,N-dimethylaminostyrene, methyl-α-acetoaminoacrylate, vinylimidazole, N-vinylpyrrole, N-vinylthiopyrrolidone, N-arylphenylenediamine, aminocarbazole, aminothiazole, aminoindole, aminopyrrole, aminoimidazole, and aminomercaptothiazole, and salts thereof.

Amide group-containing vinyl monomers: (meth)acrylamide, N-methyl(meth)acrylamide, N-butylacrylamide, diacetoneacrylamide, N-methylol(meth)acrylamide, N,N′-methylene-bis(meth)acrylamide, cinnamic acid amide, N,N-dimethylacrylamide, N,N-dibenzylacrylamide, methacrylformamide, N-methyl-N-vinylacetamide, N-vinylpyrrolidone, and the like.

Nitrile group-containing vinyl monomers: (meth)acrylonitrile, cyanostyrene, cyanoacrylates, and the like.

Quaternary ammonium cation group-containing vinyl monomers: quaternization products of tertiary amine group-containing vinyl monomers such as dimethylaminoethyl(meth)acrylate, diethylaminoethyl(meth)acrylate, dimethylaminoethyl(meth)acrylamide, diethylaminoethyl(meth)acrylamide, diallylamine, and the like (as quaternized with a quaternizing agent such as methyl chloride, dimethylsulfuric acid, benzyl chloride, dimethyl carbonate and the like).

Nitro group-containing vinyl monomers: nitrostyrene and the like.

(7) Epoxy group-containing vinyl monomers:

glycidyl(meth)acrylate, tetrahydrofurfuryl(meth)acrylate, p-vinylphenylphenyl oxide, and the like.

(8) Vinyl esters, vinyl (thio)ethers, vinyl ketones and vinyl sulfones: vinyl esters, such as vinyl acetate, vinyl butyrate, vinyl propionate, vinyl butyrate, diallyl phthalate, diallyl adipate, isopropenyl acetate, vinyl methacrylate, methyl-4-vinylbenzoate, cyclohexyl methacrylate, benzyl methacrylate, phenyl (meth)acrylate, vinyl methoxyacetate, vinyl benzoate, ethyl-α-ethoxyacrylate, alkyl(meth)acrylates having an alkyl group with 1 to 50 carbon atoms [methyl(meth)acrylate, ethyl(meth)acrylate, propyl(meth)acrylate, butyl(meth)acrylate, 2-ethylhexyl(meth)acrylate, dodecyl(meth)acrylate, hexadecyl(meth)acrylate, heptadecyl(meth)acrylate, eicosyl(meth)acrylate, etc.], dialkyl fumarates (each of the two alkyl groups is a straight-chain, branched, or cyclic group having 2 to 8 carbon atoms), dialkyl maleates (each of the two alkyl groups is a straight-chain, branched, or cyclic group having 2 to 8 carbon atoms), poly(meth)allyloxyalkanes [diallyloxyethane, triallyloxyethane, tetraallyloxyethane, tetraallyloxypropane, tetraallyloxybutane, tetramethallyloxyethane, etc.], and the like, vinyl monomers having a polyalkylene glycol chain [polyethylene glycol (molecular mass 300) mono(meth)acrylate, polypropylene glycol (molecular mass 500) monoacrylate, methyl alcohol-ethylene oxide (10 mol) adduct (meth)acrylates, lauryl alcohol-ethylene oxide (30 mol) adduct (meth)acrylates, etc.], poly(meth)acrylates [poly(meth)acrylates of polyhydric alcohols: ethylene glycol di(meth)acrylate, propylene glycol di(meth)acrylate, neopentyl glycol di(meth)acrylate, trimethylolpropane tri(meth)acrylate, polyethylene glycol di(meth)acrylate, etc.], and the like; vinyl(thio)ethers, such as vinyl methyl ether, vinyl ethyl ether, vinyl propyl ether, vinyl butyl ether, vinyl-2-ethylhexyl ether, vinyl phenyl ether, vinyl-2-methoxyethyl ether, methoxybutadiene, vinyl-2-butoxyethyl ether, 3,4-dihydro-1,2-pyran, 2-butoxy-2′-vinyloxy diethyl ether, vinyl-2-ethylmercaptoethyl ether, acetoxystyrene, phenoxystyrene; vinyl ketones, such as vinyl methyl ketone, vinyl ethyl ketone, vinyl phenyl ketone; vinyl sulfones, such as divinyl sulfide, p-vinyldiphenyl sulfide, vinylethyl sulfide, vinyl ethyl sulfone, divinyl sulfone, divinyl sulfoxide, and the like.

(9) Other vinyl monomers:

isocyanatoethyl(meth)acrylate, m-isopropenyl-α,α-dimethylbenzyl isocyanate, and the like.

(10) Fluorine atom-containing vinyl monomers:

4-fluorostyrene, 2,3,5,6-tetrafluorostyrene, pentafluorophenyl(meth)acrylate, pentafluorobenzyl(meth)acrylate, perfluorocyclohexyl(meth)acrylate, perfluorocyclohexylmethyl(meth)acrylate, 2,2,2-trifluoroethyl(meth)acrylate, 2,2,3,3-tetrafluoropropyl(meth)acrylate, 1H,1H,4H-hexafluorobutyl(meth)acrylate, 1H,1H,5H-octafluoropentyl(meth)acrylate, 1H,1H,7H-dodecafluoroheptyl(meth)acrylate, perfluorooctyl(meth)acrylate, 2-perfluorooctyl ethyl(meth)acrylate, heptadecafluorodecyl(meth)acrylate, trihydroperfluoroundecyl(meth)acrylate, perfluoronorbornylmethyl(meth)acrylate, 1H-perfluoroisobornyl(meth)acrylate, 2-(N-b utyl perfluorooctansulfonamide)ethyl(meth)acrylate, 2-(N-ethyl perfluorooctansulfonamid) ethyl(meth)acrylate, and corresponding compounds derived from α-fluoro acrylic acid such as bis-hexafluoroisopropyl itaconate, bis-hexafluoroisopropyl maleate, bis-perfluorooctyl itaconate, bis-perfluorooctyl maleate, bis-trifluoroethyl itaconate, bis-trifluoroethyl maleate, vinyl heptafluorobutylate, vinyl perfluoroheptanoate, vinyl perfluoronanoate, and vinyl perfluorooctanoate, and the like.

(Vinyl Copolymer)

The copolymers of vinyl monomers are, for example, polymers formed by copolymerizing two or more of any monomer described in the above (1) to (10) at any rate. Examples thereof include a styrene-(meth)acrylic ester copolymer, a styrene-butadiene copolymer, a (meth)acrylic acid-acrylic ester copolymer, a styrene-acrylonitrile copolymer, a styrene-maleic anhydride copolymer, a styrene-(meth)acrylic acid copolymer, a divinylbenzene copolymer, and a styrene-styrenesulfonate-(meth)acrylic ester copolymer. When fluorine is introduced to resin fine particles, any one or more of the monomer in the above (10) are copolymerized at any rate.

(Proportion of Monomers in Vinyl Resin)

It is necessary that the above resins be not completely dissolved in water at least under the condition of forming aqueous dispersion, so that the resins may form the resin fine particles in the aqueous dispersion. Therefore, when the vinyl resin is a copolymer, the relative amount of the hydrophobic monomer and hydrophilic monomer constituting the vinyl resin depends on the kinds of the selected monomers. The proportion of hydrophobic monomer is generally preferably 10% or more, and more preferably 30%. If the proportion of the hydrophobic monomer is less than 10%, the vinyl resin may become water-soluble and the uniformity of the toner particles diameter may be adversely affected. The hydrophilic monomer described herein is a monomer which is soluble in water in any proportion, while the hydrophobic monomer is a monomer other than the hydrophilic monomer, that is a monomer which is essentially immiscible with water.

(Method of Dispersing Resin Fine Particles into Aqueous Dispersion)

The methods for processing a resin into an aqueous dispersion of resin fine particles are not limited, and examples thereof include the following (a) to (h):

(a) In the case of a vinyl resin, a monomer is used as a starting material, the aqueous dispersion of resin fine particles is directly produced by the polymerization, such as suspension polymerization, emulsion polymerization, seed polymerization and dispersion polymerization.

(b) In the case of a polyaddition or condensation resin, such as a polyester resin, a polyurethane resin, and an epoxy resin, the aqueous dispersion of resin fine particles is produced by dispersing a precursor (a monomer, an oligomer and the like) or a solvent solution thereof in an aqueous medium in the presence of a suitable dispersing agent, and then curing by heating or adding a curing agent.

(c) In the case of a polyaddition or condensation resin such as a polyester resin, a polyurethane resin, and an epoxy resin, an appropriate emulsifier is dissolved in a precursor (such as a monomer, an oligomer and the like) or a solvent solution thereof which is preferably a liquid and may be liquefied by heating, and then adding water for phase-reversal emulsification.

(d) A resin prepared by a polymerization reaction, which may be any polymerization reaction mode, such as addition polymerization, ring-opening polymerization, polyaddition polymerization, addition-condensation polymerization, and condensation polymerization, in advance, is crushed with a mechanical rotary, jet type or other micropulverizer, and the resulting powder is classified to obtain resin fine particles, and then the obtained resin fine particles are dispersed in water in the presence of an appropriate dispersing agent.

(e) A resin solution in which a resin prepared by a polymerization reaction, which may be any polymerization reaction mode, such as addition polymerization, ring-opening polymerization, polyaddition polymerization, addition-condensation polymerization, and condensation polymerization, in advance, is dissolved, and the resulting resin solution is sprayed in a mist form to obtain resin fine particles, and the obtained resin fine particles are dispersed in water in the presence of an appropriate dispersing agent.

(f) A solvent is added to a resin solution in which a resin prepared by a polymerization reaction, which may be any polymerization reaction mode, such as addition polymerization, ring-opening polymerization, polyaddition polymerization, addition-condensation polymerization, and condensation polymerization, in advance, is dissolved, or a resin solution in which a resin is dissolved by heating in advance is cooled to precipitate resin fine particles, and then the solvent is removed to obtain resin fine particles, and the obtained resin fine particles are dispersed in water in the presence of a suitable dispersing agent.

(g) A resin solution in which a resin prepared by a polymerization reaction, which may be any polymerization reaction mode, such as addition polymerization, ring-opening polymerization, polyaddition polymerization, addition-condensation polymerization, and condensation polymerization, in advance, is dissolved, and the resulting resin solution is dispersed in an aqueous medium in the presence of a suitable dispersing agent, and then the aqueous dispersion is heated or decompressed to remove the solvent.

(h) A suitable emulsifier is dissolved in a resin solution in which a resin prepared by a polymerization reaction, which may be any polymerization reaction mode, such as addition polymerization, ring-opening polymerization, polyaddition polymerization, addition-condensation polymerization, and condensation polymerization, in advance, is dissolved, and then water is added for phase-reversal emulsification.

(Particle Diameter of Resin Fine Particles)

The particle diameter of resin fine particles is usually smaller than the particle diameter of toner particles, and from the viewpoint of the uniformity of particle diameter, the value of the particle diameter ratio, [volume average particle diameter of the resin fine particles]/[volume average particle diameter of the toner], is preferably 0.001 to 0.3. When the particle diameter ratio is larger than 0.3, the resin fine particles may not be efficiently adsorbed on the surface of toner, and the particle diameter distribution of the toner may tend to be wider. The volume average particle diameter of the resin fine particles can be adjusted within the above range of particle diameter ratio so that it may be suited for forming a toner having the desired particle diameter. For example, when it is desired to obtain a toner having a volume average particle diameter of 5 μm, the volume average particle diameter of the resin fine particles is preferably be 0.0025 μm to 1.5 μm, particularly preferably 0.005 μm to 1.0 μm. When it is desired to obtain a toner having a volume average particle diameter of 10 μm, the volume average diameter of the resin fine particles is preferably 0.005 μm to 3.0 μm, particularly preferably 0.05 μm to 2 μm. The volume average particle diameter can be measured by the laser Doppler system particle size analyzer (UPA 150 by Nikkiso Co., Ltd.), the laser particle size distribution analyzer LA-920 (by HORIBA, Ltd.) or Multisizer II (by Coulter).

(Surfactant)

In order to emulsify and disperse the oil phase containing the toner composition into the aqueous medium, surfactants may be added optionally. Examples of the surfactants include anionic surfactants such as alkylbenzene sulfonate, α-olefin-sulfonate and phosphate; cationic surfactants of amine salt type such as alkylamine salt, amino alcohol fatty acid derivative, polyamine fatty acid derivative and imidazoline; cationic surfactants of quaternary ammonium salt type such as alkyltrimethyl ammonium salt, dialkyldimethyl ammonium salt, alkyldimethylbenzyl ammonium salt, pyridinium salt, alkylisoquinolinium salt and benzethonium chloride; nonionic surfactants such as fatty amide derivative and polyol derivative; and amphoteric surfactants such as alanine, dodecyldi(aminoethyl)glycine, di(octylaminoethyl)glycine and N-alkyl-N,N-dimethyl ammonium betaine. In addition, the use of a surfactant having a fluoroalkyl group may largely enhance the effect even in a small amount. Examples of the anionic surfactants having a fluoroalkyl group preferably used include fluoroalkylcarboxylate having 2 to 10 carbon atoms and its metal salt, perfluoro octanesulfonyl disodium glutamate, 3-[omega-fluoroalkyloxy (C₆ to C₁₁)]-1-alkyl (C₃ to C₄) sodium sulfonate, 3-[omega-fluoroalkanoyl (C₆ to C₈)—N-ethylamino]-1-propane sodium sulfonate, fluoroalkyl (C₁₁ to C₂₀) carboxylic acid and its metal salt, perfluoroalkyl carboxylic acid (C₇ to C₁₃) and its metal salt, perfluoroalkyl (C₄ to C₁₂) sulfonic acid and its metal salt, perfluorooctane sulfonic acid diethanolamide, N-propyl-N-(2-hydroxyethyl)perfluorooctane sulfonamide, perfluoroalkyl (C₆ to C₁₀) sulfonamidepropyltrimethyl ammonium salt, perfluoroalkyl (C₆ to C₁₀)—N-ethylsulfonylglycine salt and monoperfluoroalkyl (C₆ to C₁₆) ethylphosphate. Examples of the cationic surfactants include an aliphatic primary and secondary acids or secondary amine acid having fluoroalkyl group; an aliphatic quaternary ammonium salt such as perfluoroalkyl (C₆ to C₁₀) sulfonamide propyltrimethyl ammonium salt; benzalkonium salt; benzethonium chloride; a pyridinium salt; and an imidazolinium salt.

(Protective Colloid)

The dispersed droplets may be stabilized with a polymeric protective colloid. Examples thereof include acids such as acrylic acid, methacrylic acid, α-cyanoacrylic acid, α-cyanomethacrylic acid, itaconic acid, crotonic acid, fumaric acid, maleic acid, and maleic anhydride; (meth)acrylic monomer having a hydroxyl group such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic ester, diethylene glycol monomethacrylic ester, glycerine monoacrylic ester, glycerine monomethacrylic ester, N-methylolacrylamide and N-methylolmethacrylamide; vinyl alcohols or ethers of vinyl alcohol such as vinyl methyl ether, vinyl ethyl ether and vinyl propyl ether; esters of vinyl alcohol and a compound having a carboxyl group such as vinyl acetate, vinyl propionate and vinyl butyrate; acrylamide, methacrylamide, diacetone acrylamide and methylol compounds thereof; acid chlorides such as acrylic acid chloride and methacrylic acid chloride; homopolymers or copolymers having a nitrogen atom or a heterocyclic ring thereof such as vinylpyridine, vinylpyrrolidone, vinylimidazole and ethyleneimine; polyoxyethylenes such as polyoxyethylene, polyoxypropylene, polyoxyethylene alkyl amine, polyoxypropylene alkyl amine, polyoxyethylene alkyl amide, polyoxypropylene alkyl amide, polyoxyethylene nonyl phenyl ether, polyoxyethylene lauryl phenyl ether, polyoxyethylene stearyl phenyl ester and polyoxyethylene nonyl phenyl ester; and celluloses such as methyl cellulose, hydroxyethyl cellulose and hydroxypropyl cellulose. When an acid- or alkali-soluble substance such as a calcium phosphate salt is used as a dispersion stabilizer, the calcium phosphate salt is removed from fine particles using the method in which a calcium phosphate salt is dissolved by an acid such as hydrochloric acid, followed by washing. The calcium phosphate salt can be removed by the decomposition by other enzymes. When a dispersing agent is used, the dispersing agent may be left on the surface of the toner particles. However, it is preferable that the dispersing agent is washed away from the surface of the toner particles after elongation and/or cross-linking reaction in terms of charging the toner.

<Dispersing and Emulsifying Method>

The dispersing and emulsifying method is not limited, and the known apparatus such as low-speed shearing, high-speed shearing, friction, high-pressure jet and ultrasonic apparatuses may be applied. It is preferably a high-speed shearing apparatus in order to have a particle diameter of the dispersions of 2 μm to 20 μm. For a high-speed shearing distribution apparatus, the number of revolutions is not particularly limited, but it is usually 1,000 rpm to 30,000 rpm, and more preferably 5,000 rpm to 20,000 rpm. The dispersion time is not particularly limited, but in a batch processing system, it is usually 0.1 minutes to 5 minutes. The dispersion temperature is usually 0° C. to 150° C. under pressurization, and preferably 20° C. to 90° C. High temperature is preferable from the viewpoint that the dispersions containing the toner composition which contains a polyester has low viscosity, and disperses easily.

To facilitate radical generation from the radical generator, it is preferable to heat appropriately, for example, based on half-life temperature for decomposition, in the range from 20° C. to 90° C. During the process of dispersion and desolvation, the heat treatment may be performed appropriately.

<Elongation>

In the invention, when an urea modified polyester is formed from a polyester prepolymer containing an isocyanate group, amines and a sulfonating agent are mixed in the oil phase and then amines may be reacted with the prepolymer before a toner composition is dispersed in the aqueous medium, or after the toner composition is dispersed in the aqueous medium so as to induce a reaction from the particle interface. In the latter, the urea modified polyester is preferentially formed on the surface of the toner particles to be produced, and the concentration gradient can be generated inside of the particles. The reaction time is selected depending on reactivity between an isocyanate group structure contained in the polyester prepolymer and the amines, and usually 1 minute to 40 hours, preferably 1 hour to 24 hours. The reaction temperature is usually 0° C. to 150° C., preferably 20° C. to 98° C. If necessary, the known catalysts can be used. Specifically, examples of the catalysts include a dibutyltin laurate, and a dioctyltin laurate.

<Desolvation>

To remove the organic solvent from the obtained emulsified dispersion, a method of gradually raising a temperature of the whole dispersion to completely remove the organic solvent from the droplet by vaporizing can be used. Alternatively, it is possible to spray the emulsified dispersion in a dry ambient atmosphere so as to completely remove a water-insoluble organic solvent from the droplet thereby forming toner particles, while a water dispersing agent is removed by vaporizing. Examples of the typical dry ambient atmosphere in which the emulsified dispersion is sprayed include an atmospheric air, a nitrogen gas, a carbon dioxide gas, a gaseous body in which a combustion gas is heated, and various aerial currents heated to have a temperature not less than a highest boiling point of a solvent which is particularly used. A spray dryer, a belt dryer and a rotary kiln can sufficiently remove the organic solvent in a short time to obtain a desired quality.

<Washing and Drying Step>

Well-known techniques are used in the process to wash and dry the toner particles dispersed in the aqueous medium. The solids and liquids are separated using a centrifugal separator, a filter press or the like, and the resultant toner cake is re-dispersed in ion exchanged water at a temperature of from room temperature to about 40° C. After adjusting the pH using an acid or alkali as appropriate, the solid and liquid separation process is repeated a number of times to remove impurities and the surfactant. The toner powder is then obtained by drying the resultant solids using a pneumatic dryer, a circulation dryer, a reduced pressure dryer, a vibrating fluidized drier or the like. The fine particle component of the toner may be removed using a centrifugal separator. Also, if required after drying, the toner can be adjusted to a desired particle diameter distribution using a known classifier.

<Wet Classification>

When a particle diameter distribution is wide at the time of emulsifying and dispersing, and washing and drying are performed while maintaining the wide particle diameter distribution, the obtained powder (toner powder) can be classified to have a desired particle diameter distribution. A cyclone, a decanter, a centrifugal separation, etc. enables the classification for removing fine particles in the liquid. The classified can also be carried out on the powder after drying, but it is preferable that the classification is carried out in the liquid in terms of efficiency. Unnecessary fine and coarse particles can be recycled to a kneading process to form particles. The fine and coarse particles may be wet when recycled. A dispersing agent is preferably removed from the dispersion as soon as possible, and more preferably removed at the same time when the above-classification is performed.

<External Additive Treatment>

Heterogeneous particles such as releasing agent fine particles, charge control fine particles, fluidizing agent fine particles and colorant fine particles can be mixed with a toner powder obtained after drying. Release of the heterogeneous particles from composite particles can be prevented by giving a mechanical stress to the mixed powder so as to fix and fuse them on a surface of the composite particles. Specific methods include a method of applying impact strength on a mixture by rotating a blade at a high-speed, a method of charging a mixture in a high-speed stream to accelerate such that particles thereof collide each other or composite particles thereof collide with a collision board, and the like. Examples of the apparatus include an ONG MILL by Hosokawa Micron Corp., a modified I-type mill (by Nippon Pneumatic Mfg. Co., Ltd.) with a lower pulverizing air pressure, a hybridization system by Nara Machinery Co., Ltd., a Kryptron System by Kawasaki Heavy Industries, Ltd., and an automatic mortar.

(Inorganic Fine Particles)

Inorganic particles are preferably used as an external additive for assisting in flowability of coloring particles, developing property, and charge property. The primary particle diameter of the inorganic fine particle is preferably 5 nm to 2 μm, more preferably 5 nm to 500 nm, and particularly preferably 5 nm to 200 nm. If the primary particle diameter of the inorganic fine particles added as an external additive is less than 5 nm, the inorganic fine particles tend to become buried in the surface of the toner. On the other hand, if the primary particle diameter exceeds 2 μm it is necessary to include a large amount of inorganic fine particles to secure the desired detached ratio. A primary particle diameter of the inorganic fine particles within the above range enables the simplification of the desired external additive design. The specific surface are of the inorganic fine particle by BET method is preferably 20 m²/g to 500 m²/g. The added amount of the inorganic fine particle is preferably 0.01% by mass to 5.0% by mass, more preferably 0.01% by mass to 2.0% by mass based on the toner. Examples of the inorganic fine particles include silica, alumina, titanium oxide, barium titanate, magnesium titanate, calcium titanate, strontium titanate, zinc oxide, tin oxide, silica sand, clay, mica, wollastonite, diatom earth, chrome oxide, cerium oxide, colcothar, antimony trioxide, magnesium oxide, zirconium oxide, barium sulfate, barium carbonate, calcium carbonate, silicon carbide and silicon nitride.

(Polymer Fine Particles)

Other polymer fine particles include polystyrene obtained by a soap-free emulsion polymerization, a suspension polymerization method, and a dispersion polymerization method; methacrylic acid ester copolymer, acrylic ester copolymer; condensation polymers such as silicone, benzoguanamine, nylon; and polymer particles of thermosetting resins.

(Surface-Treatment of Inorganic Fine Particles)

These inorganic fine particles are surface-treated to enhance its hydrophobic property, and it can prevent the degradation of the flowability and charge property even under high humidity. Preferable examples of the surface treatment agents include silane coupling agents, silylation agents, silane coupling agents having alkyl fluoride groups, organic titanate-based coupling agents, aluminum-based coupling agent, silicone oil, and modified silicone oil.

(Cleaning Improver)

The cleaning improver is added to the toner to remove a developer remaining on a photoconductor and on a primary transferring member after a transferring step. Examples thereof include fatty acid metal salts such as zinc stearate, calcium stearate, and stearic acid; and polymer particles prepared by soap-free emulsion polymerization such as polymethylmethacrylate particles and polystyrene particles. Among these, polymer particles with a relatively narrow particle diameter distribution are preferable, and polymer particles with a volume average particle diameter of 0.01 μm to 1 μm are more preferable.

Charge Control Agent of the Toner Base

The toner base of the present invention may contain a charge control agent if required.

(Charge Control Agent)

As the charge control agent, any known charge control agents may be used, and examples thereof include a nigrosine dye, a triphenylmethane dye, a chromium-containing metal complex dye, a molybdic acid chelate pigment, a Rhodamine dye, alkoxy amine, quaternary ammonium salt (including fluorine-modified quaternary ammonium salt), alkylamide, phosphorus as an element or a compound, tungsten as an element or a compound, fluorine activator, metal salt of a salicylic acid and metal salt of salicylic acid derivative. Specific examples thereof include BONTRON 03 (nigrosine dye), BONTRON P-51 (quaternary ammonium salt), BONTRON S-34 (metallized azo dye), E-82 (metal complex of oxynaphthoic acid), E-84 (metal complex of salicylic acid) and E-89 (phenolic condensate), manufactured by Orient Chemical Industries, Ltd.; TP-302 and TP-415 (molybdenum complex of quaternary ammonium salt) manufactured by Hodogaya Chemical Co., LTD.; COPY CHARGE PSY VP2038 (quaternary ammonium salt), COPY BLUE PR (triphenyl methane derivative), COPY CHARGE NEG VP2036 and NX VP434 (quaternary ammonium salt), manufactured by Hoechst AG; LRA-901 and LR-147 (boron complex), manufactured by Japan Carlit Co., Ltd.; copper phthalocyanine, perylene, quinacridone, azo pigments and polymer compounds having a functional group such as sulfonate group, carboxyl group and quaternary ammonium salt group.

(Amount of Charge Control Agent)

The amount of the charge control agent included in the toner base varies depending on the method for producing the toner including the type of the binder resin, the presence or absence of the optionally used additives and the dispersion method, and it may not be unambiguously determined. It is, however, based on 100 parts by mass of the binder resin, preferably 0.1 parts by mass to 10 parts by mass, more preferably 0.2 parts by mass to 5 parts by mass is used. An amount of the charge control agent of more than 10 parts by mass increases the charge property of the toner excessively and weakens the effect of the charge control agent. The increase of the electrostatic attraction with a developing roller causes the decrease in the flowability of the developer and the image quality. These may be melted and kneaded with a master batch, and a resin, may surely be added to when mixing and dispersing in an organic solvent. Moreover, it may be externally added and mixed by HENSCHEL MIXER.

(Layered Inorganic Material)

The layered inorganic materials are inorganic materials formed of combined layers with thickness of a few nanometers. Modification means to introduce organic ions to the ions between the layers.

Known examples of the layered inorganic materials include smectites (such as montmorillonite and suponite), kaolins (such as kaolinite), magadiite, and kanemite. The modified layer structure of the modified layered inorganic materials makes them highly hydrophilic. When unmodified layered inorganic materials are used in toner formed into particles by dispersion in an aqueous medium, the layered inorganic materials transfer into the aqueous medium, and the toner is unable to undergo a shape change. Through modification, however, the layered inorganic materials become more hydrophilic, making it easier for them to exist on the surface of the base particles when the toner particles are formed. Thus, when the toner is dispersed and formed into particles, the charge adjustment function is sufficient. In this process, the amount of modified layered inorganic materials contained in the toner material is preferably from 0.05 mass % to 2 mass %.

The modified layered inorganic materials used in the present invention are preferably minerals with a smectite based crystal structure modified using organic cation. By replacing the bivalent metal part of the layered inorganic materials with a trivalent metal, it is possible to introduce metal anions. However, since introducing metal anion makes the layered inorganic materials more hydrophilic, a layered inorganic compound with metal anion at least partially modified using an organic anion is preferable.

Examples of organic material ion modified agents, which are layered inorganic materials with at least a portion of the ions modified using organic ions to form the modified layered inorganic material, include quaternary alkyl-ammonium salts, phosphonium salts, and imidazolium salts. Among these, however, quaternary alkyl-ammonium salts are preferable. Examples of the quaternary alkyl-ammonium include trimethyl-stearyl ammonium, dimethyl-stearyl benzyl ammonium, dimethyl octadecyl ammonium, and oleyl-bis(2-hydroxyethyl)methyl ammonium.

Examples of the organic material ion modified agent include sulfates, sulfonates, carbonates, and phosphates having branched, non-branching or ring alkyl (C₁ to C₄₄), alkenyl (C₁ to C₂₂), alkoxy (C₈ to C₃₂), hydroxy alkyl (C₂ to C₂₂), ethylene oxide, propylene oxide, or the like. Carboxylic acid having an ethylene oxide skeleton is preferable.

By modifying at least a portion of the layered inorganic materials with organic material ions, the layered inorganic materials become appropriately hydrophobic and the oil phase that includes at least one of toner composition and a precursor of the toner composition has a non-newtonian viscosity. This enables the toner shape to change. At this point, the organic material ion-modified layered inorganic material preferably accounts for from 0.05% by mass to 2% by mass of the toner material.

The layered inorganic material in which a portion is modified with organic material ions can be selected as appropriate. Examples include montmorillonite, bentonite, hectolite, attapulgite, sepiolite, and mixtures thereof. Among these, organic modified montmorillonite and bentonite are preferable because viscosity can be easily adjusted, without affecting the toner characteristics, and because the amount to be added can be small.

Examples of commercial products of the layered inorganic materials in which a portion is modified with organic cation include: quaternium-18 bentonites such as Bentone 3, Bentone 38, and Bentone 38V (manufactured by Rheox, Inc.), Tixogel VP (manufactured by United Catalyst, Ltd.), and Claytone 34, Claytone 40, and Claytone XL (manufactured by Southern Clay Products, Inc.); stearalkonium bentonites such as Bentone 27 (manufactured by Rheox, Inc.), Tixogel LG (manufactured by United Catalyst, Ltd.), and Claytone AF and Claytone APA (manufactured by Southern Clay Products, Inc.); and quaternium-18/benzalkonium bentonites such as Claytone HT and Claytone PS (manufactured by Southern Clay Products, Inc.). Particularly preferable are Claytone AF and Claytone APA. A particularly preferable layered inorganic material part-modified using organic anion is DHA-4A (manufactured by Kyowa Chemical Industry Co., Ltd.) modified using the organic anion, as expressed in the general formula (I) below. Examples of the general formula (I) include Hitenor 330T (manufactured by Dai-Ichi Kogyo Seiyaku Co., Ltd.).

General formula 1 (1): R₁(OR₂)ₙOSO₃M where R₁ is an alkyl group having 13 carbon atoms, R₂ is an alkyl group having from 2 to 6 carbon atoms, n is an integer from 2 to 10, and M is a metallic element with a valence of 1.

Using the modified layered inorganic materials makes the layered inorganic materials appropriately hydrophobic, enabling them to exist more easily on the surface of drops, and thereby altering the toner surface to enable charge properties to be realized.

The analysis and evaluation of the toner was performed as follows.

The following describes an evaluation of a single component developer. However, with appropriate additive processing and use of an appropriate carrier, the toner of the present invention may be one component of a two component developer.

(Binding Strength of External Additive)

Three grams of toner was added to 30 cc of surfactant solution diluted by a factor of 10 and, after sufficient mixing, the solution was energized at 40 W for 1 minute using a ultrasound homogenizer. After separating and washing the toner, a drying process was performed. The binding strength of the external additives was then found by using a X-ray fluorescence spectrometer to find a ratio between the amounts of bound inorganic particles before and after the processing. The X-ray fluorescence analysis was carried out on the dry toner yielded by the above processing and on the toner from before the above processing using an XRF-1700 wavelength dispersive-type X-ray fluorescence spectrometer (manufactured by Shimadzu Co., Ltd.).

In both cases, 2 g of toner were added at a pressure of 1 N/cm² for 60 seconds to form a toner palette, and an amount of one or more element in the inorganic fine particles (for instance, silicon in the case of silica) was measured using an amount detecting method.

(Particle Diameter (Coulter))

The following describes a method for measuring the particle size distribution of toner particles. Examples of measurement devices for measuring particle size distribution of the toner particles using the coulter counter method include the Coulter Counter TA-II and the Coulter Multisizer (both manufactured by Coulter Electronics, Ltd.). The following describes the measurement methods.

First, 0.1 ml to 5 ml of surfactant (preferably alkyl benzene sulfonate) is added to 100 ml to 150 ml of electrolyte solution as a dispersant. The electrolyte solution is approximately 1% NaCl aqueous solution prepared using grade 1 sodium chloride. One example of such an aqueous solution is ISOTON-II (manufactured by Coulter Electronics, Ltd.). At this point, 2 mg to 20 mg of test sample is added as a solid block. The electrolyte solution with the test sample in suspension undergoes dispersion processing for 1 minute to three minutes in an ultrasound dispersion vessel. The measurement device then measures a toner particle volume and number of toner particles, and calculates a volume distribution and number distribution using a 100 μm aperture. The toner weight average particle diameter (Dv) and the toner number average particle diameter (Dp) can be found from the obtained distributions.

Thirteen channels are used: from 2.00 μm up to but not including 2.52 μm; from 2.52 μm up to but not including 3.17 μm; 3.17 μm up to but not including 4.00 μm; from 4.00 μm up to but not including 5.04 μm; from 5.04 μm up to but not including 6.35 μm; from 6.35 μm up to but not including 8.00 μm; from 8.00 μm up to but not including 10.08 μm; from 10.08 μm up to but not including 12.70 μm; from 12.70 μm up to but not including 16.00 μm; from 16.00 μm up to but not including 20.20 μm; from 20.20 μm up to but not including 25.40 μm; from 25.40 μm up to but not including 32.00 μm; and from 32.00 μm up to but not including 40.30 μm. Thus, particle diameters from 2.00 μm up to but not including 40.30 μm can be used.

(Average Circularity)

In the present embodiment, a toner with circular particles is preferably used. In one appropriate method to measure the shape of the toner particles, a suspension including the particles is passed through an imaging unit detection belt on a flat plate using an optical detection belt, an image of the particles is optically detected using a CCD camera, and the detected image is analyzed. The average circularity is then the value obtained when the perimeter length of a circle corresponding to the projected area obtained using this method is divided by the actual particle perimeter length. This value is calculated by the FPIA-2000 flow-type particle image distribution analyzer as the average circularity. Specifically, in the measurement method, a surfactant, preferably 0.1 ml to 0.5 ml of alkyl benzene sulfonate, is added as dispersant to a container holding 100 ml to 150 ml of water with solid impurities removed and 0.1 to 0.5 g of test sample is further added. The suspension with the test sample dispersed therein undergoes approximately 1 minute to 3 minutes of dispersion processing in an ultrasound dispersion vessel. When the dispersion concentration is from 3,000 particles/μl to 10,000 particles/μl, the device finds the shape and distributions of the toner. The circularity of the toner particles can then be calculated. It is preferable that the toner circularity be from 0.95 to 0.99. Keeping the toner circularity in the above-described range simplifies control of the detached ratio of inorganic fine particles. When the toner circularity is less than 0.95, the inorganic fine particles become more difficult to be released. When the toner circularity exceeds 0.99, the inorganic fine particles are difficult to be fixed to the exterior of the toner particles.

The volume average particle diameter of the toner is from 4 μm to 8 μm. By keeping the volume average particle diameter in the above described range, it is possible to ensure that the toner has the desired flowability. When the volume average particle diameter of the toner is less than 4 μm, the toner tends to come out of the sleeve. On the other hand, when the volume average particle diameter exceeds 8 μm, consumption of toner increases and a large toner box is needed, making it difficult to achieve the intended objectives.

(Cover Ratio)

The cover ratio calculation method uses the following formula.
Cover ratio(%)(Wt/Wc)×(ρc/ρt)×(Dc/Dt)×(¼)×100 formula (3)

In formula (3), Dc is the weight average particle diameter (μm) of the carrier, Dt is the weight average particle diameter of the toner (μm), Wt is the toner weight (g), Wc is the carrier weight (g), pt is the true density of the toner (g/cm³), and ρc is the true density of the carrier (g/cm³).

In the present embodiment, it is preferable that a cover ratio of the toner surface in the developing unit by the inorganic fine particles be from 50% to 200%. When the cover ratio is in the above-described range, it is easy to adjust the amount of external additive released. Adjustment of the cover ratio is performed by varying the amount of inorganic fine particles. When the cover ratio is less than 50%, the amount of external additive released is insufficient, and the photoconductor cleaning function tends to deteriorate. When the cover rate exceeds 200%, filming caused by external additive released is more likely to occur. Both of these conditions make it more difficult to achieve the intended objectives.

(Evaluation of Amount of Charge)

A toner treated with an external additive (i.e. a developer) was used in continuous printing of a prescribed print pattern having a B/W ratio of 6% in an N/N environment (23° C., 45%). After printing 50 and 2000 sheets in the N/N environment (durability tests), toner was absorbed from the development roller during white paper pattern printing, and the amount of charge on the toner was measured using an electrometer. The amount of charge on the toner after printing 50 and 2000 sheets was then evaluated.

A: absolute difference in the amount of charge ranging from 15 μC/g to 25 μC/g.

B: absolute difference in the amount of charge ranging from 10 μC/g to 15 μC/g.

C: absolute difference in the amount of charge being 10 μC/g or less.

(Evaluation of Filming)

A toner treated with an external additive (i.e. a developer) was used in continuous printing of a prescribed print pattern having a B/W ratio of 6% in an N/N environment (23° C., 45%). After printing 2000 sheets in the N/N environment (durability test), the photoconductor was evaluated by eye. The photoconductor was evaluated as follows.

A: Filming did not occur on the photoconductor. No problems were observed.

B: A small amount of filming occurred on the photoconductor, but not on the copied images. Problems did not inhibit use.

C: Filming occurred on the photoconductor, and the effect on the images could be confirmed. Problems inhibited use.

(Detached Ratio)

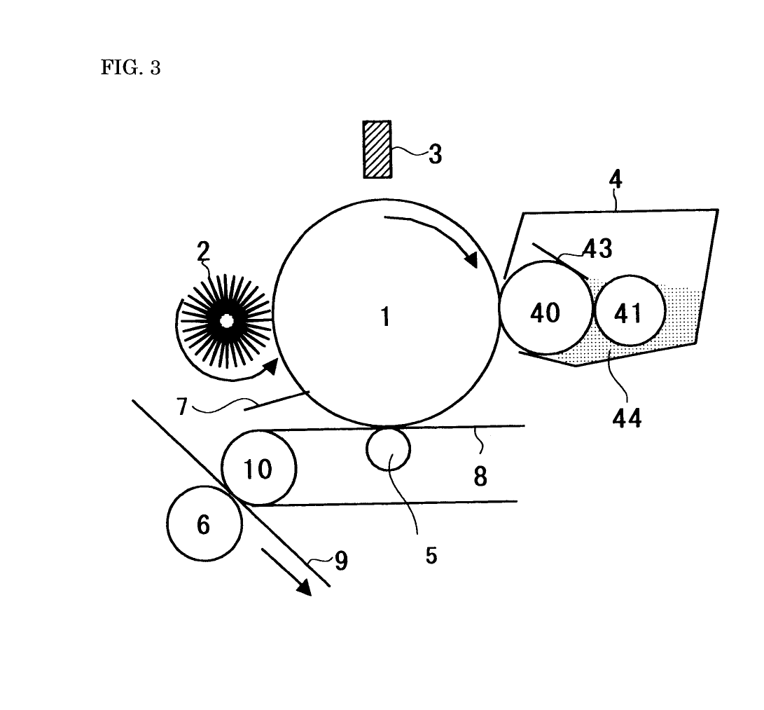

Ipsio CX2500 (manufactured by Ricoh Co., Ltd.) was used to continuously print 1,000 sheets of a solid image chart in an N/N environment (23° C., 45%). The toner gathered by the toner gathering unit 7 provided, as in the device shown in FIG. 3, between the nip part (transfer unit), which includes the latent image bearing member 11 and the intermediate transfer member 8, and the charging unit 2 (collecting unit) is gathered in a toner disposal box. The non-transferred toner T1 was then sampled as shown in FIG. 2.

Ipsio CX2500 (manufactured by Ricoh Co., Ltd.) with the above described toner gathering unit removed was used to print 1,000 sheets continuously of a solid image chart in an N/N environment (23° C., 45%). The toner T2 (see FIG. 2), which is the toner temporarily collected in the charging member 2 (collecting unit, brush) and which is in the same external additive release state as the passed toner, was sampled. The amount of the toner T2 sampled was 2 g.

The detached ratio for the external additives is obtained by calculating a ratio between the amounts of attached inorganic particles before and after processing, using an X-ray fluorescence spectrometer. The X-ray fluorescence analysis was carried out on the sampled toners using an XRF1700 wavelength dispersive X-ray fluorescence spectrometer (manufactured by Shimadzu Co., Ltd). In both cases, 2 g were added at a pressure of 1 N/cm² for 60 seconds to form a toner palette, and an amount of one or more element in the inorganic fine particles (for instance, silicon in the case of silica) was measured using an amount detecting method. When the amount of inorganic fine particles in the initial toner is denoted A, the amount of inorganic fine particles in the non-transferred toner is denoted B and the amount of inorganic particles after passing by the brush is denoted C, the respective detached ratios (R1 and R2) are expressed by the following formulae.
R1(%)=100−B/A×100
R2(%)=100−C/A×100
(Molecular Weight)

The molecular weight of the polyester resin or vinyl copolymer resin was measured by normal GPC (Gel Permeation Chromatography) under the following conditions.

Instrument: HLC-8220GPC (Tosoh Co., Ltd.)

Column: TSK gel Super HZM-M: 3 columns

Temperature: 40° C.

Solvent: THF (tetrahydrofuran)

Flow rate: 0.35 mL/minute

Test sample: 0.01 mL of test sample at concentration of 0.05% to 0.6% is injected.

From the toner resin molecular weight distribution measured according to the above conditions, a weight average molecular weight (Mw) is calculated using molecular weight calibration curves obtained from monodisperse polystyrene standard samples. Ten monodisperse polystyrene standard samples with molecular weights ranging from 5.8×100 to 7.5×1,000,000 were used.

(Glass Transition Point)

The glass transition points of the polyester resin or vinyl copolymer is measured using, for instance, a differential scanning calorimeter (such as a DSC-6220R manufactured by Seiko Instruments Co., Ltd.). After heating the sample to 150° C. at a rate of 10° C./min from room temperature, the sample is held at 150° C. for 10 min, cooled to room temperature, allowed to stand for 10 min, and then reheated to 150° C. at 10° C./min. The glass transition point can then be found at the intersection of the baseline below the glass transition point and a tangent of the curve section indicating the glass transition point.

(Particle Diameter of Fine Particles)

The particle diameter of the vinyl copolymer resin or other fine particles can be measured in the form of dispersion using a measurement instrument such as LA-920 (manufactured by Horiba, Ltd) or UPA-EX150 (Nikkiso Co., Ltd.).

(Amount of Toner of Opposite Polarity)

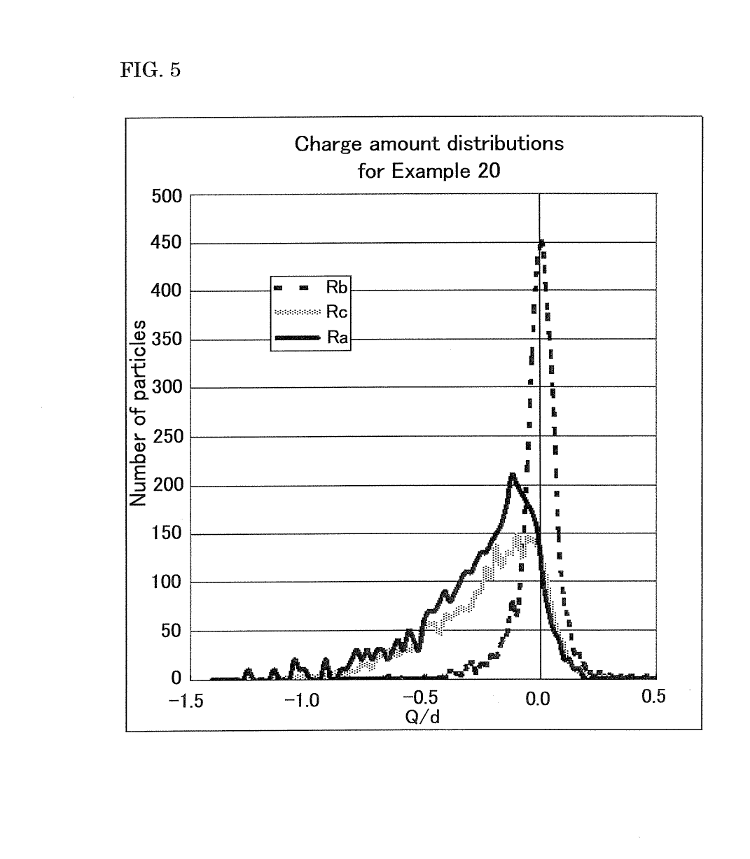

An E-Spurt Analyzer (manufactured by Hosokawa Micron, Ltd.), which makes use of laser Doppler method, is used to measure the amount of toner with opposite polarity on the latent electrostatic image bearing member in each process, initially and after 1,000 sheets of printing. FIG. 5 shows an example of results from measurement of charge distribution.

(1) Measurement Conditions

Field voltage (measurement unit voltage): 0.1 kV

Particle density: 1.1

Gas supply (supply unit N₂ emission pressure): 0.03 Mpa

Measurement unit suction flow: 0.35 l/min

Number of particles: 3000

(2) Measurement Method

(2)-1. Ra Measurement

Solid black printing over entire portrait-form A4 page is carried out. The machine is forcibly stopped with 5 cm from the leading edge of the paper transferred. The toner charge distribution of the toner left on the latent electrostatic image bearing member is measured over a 5 cm range from the contact point between the latent electrostatic image bearing member and the transfer member.

(2)-2. Rb Measurement

Solid black printing over an entire portrait-form A4 page is carried out. The machine is forcibly stopped just before the toner left on the latent electrostatic image bearing member reaches the latent electrostatic image bearing member charging member after transfer. The toner charge distribution of the toner left on the latent electrostatic image bearing member is measured over a 5 cm range from the latent electrostatic image bearing member charging member.

(2)-3. Rc Measurement

Solid black printing over an entire portrait-form A4 page is carried out. The machine is forcibly stopped after approximately 5 cm of the image on the latent electrostatic image bearing member has been developed. The toner charge distribution of the toner on the latent electrostatic image bearing member before the transfer member contact portion is measured over a 5 cm range from the contact point between the latent electrostatic image bearing member and the transfer member.

<Evaluation Method>

Evaluation of Appropriateness of Cleanerless System: Developing and Collecting Property

In an IPSIO CX3000 (manufactured by Ricoh Co., Ltd), the charging roller was replaced with a brush roller, and the latent electrostatic image bearing member cleaning blade was replaced with a conductive sheet provided to contact the surface of the latent electrostatic image bearing member so as to form the latent electrostatic image bearing member cleanerless system shown in the schematic below. In an N/N environment (23° C., 45%), 1,000 sheets of a prescribed print pattern having a B/W ratio of 6% were printed continuously in monochrome mode. The developing and collecting properties were then ranked to evaluate the appropriateness of the cleanerless system.

The developing and collecting property was evaluated by removing the toner left on the photoconductor after completing 1000 pages of printing with a tape, and measuring L* using an X-rite 939 spectrodensitometer.

AA: 90 or more

A: from 85 to less than 90

B: from 80 to less than 85

(Process Cartridge)

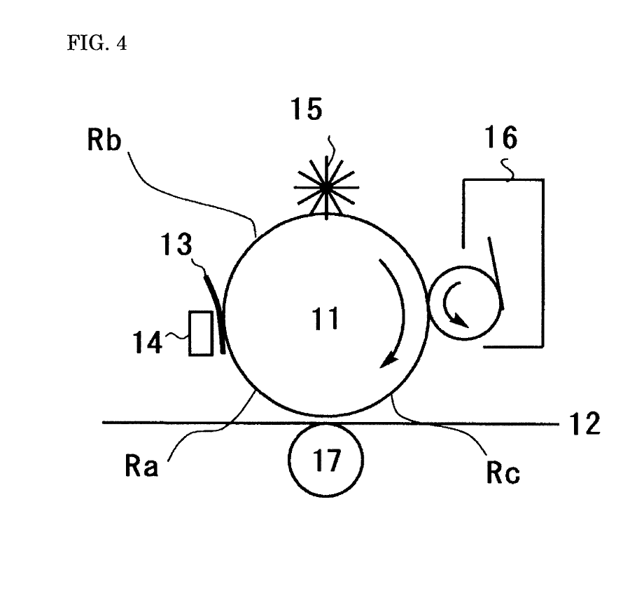

The developer of the present invention can be used in an image forming apparatus having a process cartridge as shown in FIG. 4. The present invention is directed to an image forming method by which images are recorded without using a device for cleaning residual toner left after image transfer. By using this cleanerless image forming method, not only is it possible to dispose of the cleaning device, but the toner left on the latent electrostatic image bearing member 11 can be reused during image forming. This technology is therefore extremely effective in reducing the load on the environment.

Also, since these cleanerless image forming methods do not make use of a collection vessel, they have an advantage in terms of reducing device size. Thus, it is possible to meet the small device size requirements for printers and copiers which use electrophotographic methods. Hence, the cleanerless image forming method is an extremely effective technique both for meeting requirements relating to environmental issues and for contributing to the size reduction of image forming apparatus.

The present invention includes components such as a latent electrostatic image bearing member 11, a latent electrostatic image charging unit 15, a developing unit 16, and a charging unit 13 for recharging the toner left on the surface of the latent electrostatic image bearing member 11 after transferring an image from the latent electrostatic image bearing member 11 to the next process. A plurality of these components can be integrated into a process cartridge, and the process cartridge can be removably attached to an image forming apparatus such as a photocopier or a printer. In particular, the charging unit 13 may be combined with the latent electrostatic image bearing member 11 to form a single unit which can be freely and removably attached to the image forming apparatus. The latent electrostatic image charging unit 15 and the developing unit 16 may also be included in the single unit.

The process cartridge shown in FIG. 4 includes the latent electrostatic image bearing member 11, the latent electrostatic image charging unit 15, the charging unit 13 for recharging the toner left on the surface of the latent electrostatic image bearing member 11 after transferring the image from the latent electrostatic image bearing member 11 to the next process, and the developing unit 16.

In the following description of operations, the latent electrostatic image bearing member is driven to rotate at a prescribed speed. As the latent electrostatic image bearing member 11 rotates, the circumferential surface thereof is uniformly charged of a prescribed positive or negative potential by the charging unit 15, and receives image exposure light from an image exposure unit which uses slit exposure, laser beam scanning exposure or the like. A latent electrostatic image is thereby sequentially formed on the circumferential surface of the latent electrostatic image bearing member 11. The formed latent electrostatic image is then developed with toner by the developing unit 16. The developed toner image is then sequentially transferred by a transferring unit 17 to a transfer member that is supplied between the latent electrostatic image bearing member 11 and a transferring unit 17 in time with the rotation of the latent electrostatic image bearing member 11 from paper supplying section. Having received the image transfer, the transfer member separates from the surface of the latent electrostatic image bearing member 11 and enters an image fixing unit, where the image is fixed. The transfer member is then outputted to an external part of the device as a copy or printout. After image transfer, the toner left on the surface of the latent electrostatic image bearing member 11 is recharged by the charge giving unit 13 for recharging the toner left on the surface of the latent electrostatic image bearing member 11 after the transfer process. Next, the recharged toner is passed through the latent electrostatic image bearing member charging unit, collected in a development process, and again used for image formation.

(Charging Member)

From the point of view of toner attachment properties, the charging unit 13 for recharging the toner left on the surface of the latent electrostatic image bearing member 11 after the transfer process from the latent electrostatic image bearing member 11 is preferably a conductor. This is because the toner particles attach due to charging of the charging unit 13 if the charging unit 13 is an insulator.

The resistance of the charging member is preferably from 10 to 10⁹Ω. The charging unit 13 may be a roller, a brush, a sheet or have another form, but, from the point of view of reset properties of the attached toner, is preferably a sheet.

The charging member is desirably a sheet selected from nylon, PTFE, PVDF, or urethane, but, from the point of view of toner chargeability, is preferably formed form PTFE or PVDF.

When the charging member is a conductive sheet, it is preferable, from the point of view of contact pressure with the latent electrostatic image bearing member, that the thickness is from 0.05 mm to 0.5 mm. When the charging member is a conductive sheet, it is preferable, from the point of view of contact time for charging of the toner, that the nip width of the contact with the latent image bearing member is from 1 mm to 10 mm. The voltage applied to the charging member is, from the point of view of toner charging, preferably from −1.4 kV to 0 kV.

### EXAMPLES

Hereinafter, with referring to Examples and Comparative Examples, the present invention will be explained in detail and the following Examples and Comparative Examples should not be construed as limiting the scope of this invention. In Examples and Comparative Examples, all part(s) and percentage (%) are expressed by mass-basis unless indicated otherwise.

### Example 1

### Synthesis of Low-Molecular Polyester

In a reaction vessel equipped with a cooling tube, an agitator, and a nitrogen introduction tube, 220 parts of bisphenol A ethylene oxide 2 mole adduct, 561 parts of bisphenol A propylene oxide 3 mole adduct, 218 parts of terephthalic acid, 48 parts of adipic acid and 2 parts of dibutyl tin oxide were charged and reacted at a normal pressure and a temperature of 230° C. for 8 hours. After it was further reacted at a reduced pressure of 10 mmHg to 15 mmHg for 5 hours, 45 parts of trimellitic anhydride was added to the reaction vessel. The mixture was reacted at a normal pressure and a temperature of 180° C. for 2 hours to obtain “Low-Molecular Polyester 1”. “Low-Molecular Polyester 1” had a number-average molecular mass of 2,500, a weight average molecular mass of 6,700, a glass transition temperature (Tg) of 43° C. and an acid value of 25 mg KOH/g.

(Synthesis of Prepolymer)

In a reaction vessel equipped with a cooling tube, an agitator, and a nitrogen introduction tube, 682 parts of bisphenol A ethylene oxide 2 mole adduct, 81 parts of bisphenol A propylene oxide 2 mole adduct, 283 parts of terephthalic acid, 22 parts of trimellitic anhydride and 2 parts of dibutyl tin oxide were charged and reacted at a normal pressure and a temperature of 230° C. for 8 hours. It was further reacted at a reduced pressure of 10 mmHg to 15 mmHg for 5 hours to obtain “Intermediate Polyester 1”. “Intermediate Polyester 1” had a number average molecular mass of 2,100, a weight average molecular mass of 9,500, a glass transition temperature (Tg) of 55° C., an acid value of 0.5 mg KOH/g and a hydroxyl value of 49 mg KOH/g.

Next, in a reaction vessel equipped with a cooling tube, an agitator, and a nitrogen introduction tube, 411 parts of “Intermediate Polyester 1”, 89 parts of isophorone diisocyanate and 500 parts of ethyl acetate were charged and reacted at a temperature of 100° C. for 5 hours to obtain “Prepolymer 1”. “Prepolymer 1” had a free isocyanate content of 1.53% by mass.

(Synthesis of Master Batch)

40 parts of Carbon black (REGAL™ 400R by Cabot corporation), 60 parts of a polyester resin as a binder resin (RS-801 by Sanyo Chemical Industries, Ltd., acid value of 10, Mm of 20,000, Tg of 64° C.), and 30 parts of water were mixed in HENSCHEL MIXER to obtain a mixture of a pigment aggregate in which water permeated. After it was kneaded using a two-roller mill at a roller surface temperature of 130° C. for 45 minutes, and then the mixture was milled to 1 mm in diameter with a pulverizer to obtain “Master Batch 1”.

(Preparation of Dispersion of Pigment and Wax (Oil Phase))

In a vessel with an agitator and a thermometer, 378 parts of “Low-Molecular Polyester 1”, 127 parts of paraffin wax, 127 parts of a wax dispersing agent (described in JP-A No. 2004-246305) and 947 parts of ethyl acetate were charged. After it was heated up to 80° C. while being agitated and maintained at 80° C. for 5 hours, the mixture was cooled down to 30° C. in one hour. Next, 500 parts of “Master Batch 1” and 500 parts of ethyl acetate were charged in the vessel, which was mixed for one hour to obtain “Raw Material Solution 1”.

In a vessel 1,324 parts of “Raw Material Solution 1” was transferred, and the carbon black and the wax were dispersed in three passes using a bead mill, manufactured by Ultraviscomill by Aimex Co., Ltd. Here, the bead mill was filled with 0.5-mm zirconia beads at 80% by volume, and in each pass “Raw Material Solution 1” was introduced in the bead bill at a liquid feeding rate of 1 kg/hr, and was dispersed at a disk circumferential velocity of 6 m/sec. Next, 1,324 parts of 65% ethyl acetate solution of “Low-Molecular Polyester 1” was added, and the mixture was dispersed in one pass using the bead mill under the same conditions mentioned above to obtain “Pigment-Wax Dispersion 1”. “Pigment-Wax Dispersion 1” was prepared by adding ethyl acetate to be a solid concentration (130° C., 30 minutes) of 50%.

(Preparation of Aqueous Medium)

953 parts of water, 88 parts of a 25 mass % aqueous dispersion of vinyl resin (styrene-methacrylic acid-sodium salt of butyl acrylate-methacrylic acid ethylene oxide adduct sulfate ester copolymer), 90 parts of a 48.5 mass % aqueous solution of sodium dodecyldiphenyl ether disulfonate (ELEMINOL MON-7, manufactured by Sanyo Chemical Industries, Ltd.), 113 parts of ethyl acetate, and 11.2 parts of potassium persulfate as a radical generator were mixed and stirred to obtain a milky white liquid. This was hereinafter referred to as “Aqueous Phase 1”.

(Emulsification)

In a vessel, 976 parts of “Pigment-Wax Dispersion 1”, and 6.0 parts of isophoronediamine as amines were charged and mixed by means of T.K. HOMO MIXER manufactured by Tokushu Kika Kogyo Co., Ltd. at 5,000 rpm for 1 minute. After 137 parts of “Prepolymer 1” was added in the vessel and mixed by means of T.K. HOMO MIXER manufactured by Tokushu Kika Kogyo Co., Ltd. at 5,000 rpm for 1 minute, 1,200 parts of “Aqueous Phase 1” was added to the vessel, and the mixture was mixed by means of T.K. HOMO MIXER at 13,000 rpm for 15 minutes to obtain “Emulsified Slurry 1”.

(Desolvation)

In a vessel equipped with an agitator and a thermometer, “Emulsified Slurry 1” was introduced and desolvated at 30° C. for 8 hours. Then, it was aged at 60° C. for 10 hours to obtain “Dispersed Slurry 1”.

(Washing and Drying)

After 100 parts of “Dispersed Slurry 1” was filtered under a reduced pressure:

(1) 100 parts of ion-exchanged water was added to the filter cake, mixed using T.K. HOMO MIXER at 12,000 rpm for 10 minutes, and then filtered;

(2) 900 parts of ion-exchanged water was added to the filter cake of (1), mixed using T.K. HOMO MIXER at 12,000 rpm for 30 minutes while applying ultrasonic vibrations and then filtered under a reduced pressure. This operation was repeated until the conductivity of the slurry liquid became 10 μC/cm or less.

(3) 10% hydrochloric acid was added to the slurry liquid of (2) to be pH of 4, agitated by means of Three-One Motor for 30 minutes, and then filtered; and

(4) 100 parts of ion-exchanged water was added to the filter cake of (3), mixed by means of T.K. HOMO MIXER at 12,000 rpm for 10 minutes and then filtered. This operation was repeated until the conductivity of the slurry liquid became 10 μC/cm or less to obtain “Filter Cake 1”.

“Filter Cake 1” was dried at 45° C. for 48 hours in a circulating air dryer, and then, it was passed through a sieve of 75 μm mesh to obtain “Toner Base 1”. “Toner Base 1” had the volume average particle diameter (Dv) of 6.7 μm, the number average particle diameter (Dp) of 6.0 μm, the ratio of Dv to Dp (Dv/Dp) of 1.13, and the average circularity of 0.97.

(External Addition)

100 parts of [toner base 1] and 2 parts of NAX 50 silica were mixed in a HENSCHEL MIXER (at a revolving speed of 40 m/sec for 120 seconds) to yield a developer A of the present invention.

### Examples 2 to 9 and Comparative Examples 1 to 4

Examples 2 to 9 and Comparative Examples 1 to 4 were conducted as in Example 1 except that the types and amounts of external addition of inorganic fine particles and the mixing conditions were changed as shown in Table 1.

Table 1 summarizes the results from Examples and Comparative Examples.

TABLE 1

| | | | | Mixing conditions | | | | | | |
|---|---|---|---|---|---|---|---|---|---|---|
| | | Inorganic fine particles | | Rotation | | Detached ratio [%] | | | | |
| | | Particle diameter | Additive | speed | | Non-transferred | Collecting | | Photoconductor | |
| | Type | [nm] | amount [%] | [m/s] | Time [s] | (R1) | unit (R2) | R1:R2 | filming | Charge |
| Example 1 | NAX50 | 35 | 2 | 40 | 120 | 10 | 35 | 1:3.5 | A | A |
| Example 2 | NAX50 | 35 | 2 | 40 | 60 | 20 | 80 | 1:4 | A | B |
| Example 3 | NAX50 | 35 | 2 | 40 | 180 | 5 | 30 | 1:6 | A | A |
| Example 4 | NX90 | 25 | | 40 | 100 | 9 | 30 | 1:3.3 | A | A |
| Example 5 | NX90 | 25 | 2.5 | 30 | 100 | 18 | 50 | 1:2.8 | A | A |
| Example 6 | HT2OTM | 12 | 2 | 40 | 120 | 20 | 30 | 1:1.5 | B | A |
| Example 7 | X24 | 110 | 2 | 40 | 300 | 2 | 50 | 1:25 | A | A |
| Example 8 | TG811F | 7 | 2 | 40 | 60 | 10 | 30 | 1:3 | A | A |
| Example 9 | TG811F | 7 | 1 | 40 | 120 | 8 | 30 | 1:3.75 | A | A |
| | NAX50 | 35 | 1 | | | | | | | |
| Comparative | NAX50 | 35 | 2 | 40 | 300 | 2 | 10 | 1:5 | C | A |
| Example 1 | | | | | | | | | | |
| Comparative | HT20TM | 12 | 2 | 40 | 60 | 10 | 95 | 1:9.5 | A | C |
| Example 2 | | | | | | | | | | |
| Comparative | X24 | 110 | 10 | 40 | 120 | 25 | 50 | 1:2 | A | C |
| Example 3 | | | | | | | | | | |
| Comparative | TG811F | 7 | 1 | 40 | 180 | 20 | 28 | 1:1.4 | C | A |
| Example 4 | NAX50 | 35 | 1 | | | | | | | |

In Examples 1 to 9 in Table 1 the requirements for the toner of the present invention are satisfied, these being that the detached ratio R1 of inorganic particles (denoted as A in Table 1) from the non-transferred toner is from 2% to 20%, the detached ratio R2 of the inorganic particles (denoted as B in Table 1) from toner that has passed through the collecting unit is from 20% to 80%, and the ratio of the detached ratio R2 to the detached ratio R1 (A:B in Table 1) is 1.5 or more. Since these requirements were satisfied, filming was not seen or was only seen at a level that had no practical effect, and the absolute charge difference was from 15 μC/g to 25 μC/g. As a result, Examples 1 to 9 offered excellent results. In contrast, Comparative Examples 1 to 4 fail to satisfy the requirements for the above-described toner. Hence, filming occurred at a level that causes practical problems or the absolute charge difference is 10 μC/g or less, and a favorable outcome was not obtained.

### Example 10

### Synthesis of Polyester

(Polyester 10) In a reaction vessel equipped with a cooling tube, an agitator, and a nitrogen introduction tube, 553 parts of bisphenol A ethylene oxide 2 mole adduct, 196 parts of bisphenol A propylene oxide 2 mole adduct, 220 parts of terephthalic acid, 45 parts of adipic acid and 2 parts of dibutyl tin oxide were charged and reacted at a normal pressure and a temperature of 230° C. for 8 hours. After it was further reacted at a reduced pressure of 10 mmHg to 15 mmHg for 5 hours, 46 parts of trimellitic anhydride was added to the reaction vessel. The mixture was reacted at a normal pressure and a temperature of 180° C. for 2 hours to obtain “Polyester 10”. “Polyester 10” had a number-average molecular mass of 2,200, a weight average molecular mass of 5,600, a glass transition temperature (Tg) of 43° C. and an acid value of 13 mg KOH/g.

(Synthesis of Prepolymer)

In a reaction vessel equipped with a cooling tube, an agitator, and a nitrogen introduction tube, 682 parts of bisphenol A ethylene oxide 2 mole adduct, 81 parts of bisphenol A propylene oxide 2 mole adduct, 283 parts of terephthalic acid, 22 parts of trimellitic anhydride and 2 parts of dibutyl tin oxide were charged and reacted at a normal pressure and a temperature of 230° C. for 8 hours. It was further reacted at a reduced pressure of 10 mmHg to 15 mmHg for 5 hours to obtain “Intermediate Polyester 10”. “Intermediate Polyester 10” had a number average molecular mass of 2,100, a weight average molecular mass of 9,500, a glass transition temperature (Tg) of 55° C., an acid value of 0.5 mg KOH/g and a hydroxyl value of 49 mg KOH/g.

Next, in a reaction vessel equipped with a cooling tube, an agitator, and a nitrogen introduction tube, 411 parts of “Intermediate Polyester 10”, 89 parts of isophorone diisocyanate and 500 parts of ethyl acetate were charged and reacted at a temperature of 100° C. for 5 hours to obtain “Prepolymer 10”. “Prepolymer 10” had a free isocyanate content of 1.53% by mass.

(Synthesis of Master Batch)

40 parts of Carbon black (REGAL™ 400R by Cabot corporation), 60 parts of a polyester resin as a binder resin (RS-801 by Sanyo Chemical Industries, Ltd., acid value of 10, Mm of 20,000, Tg of 64° C.), and 30 parts of water were mixed in HENSCHEL MIXER to obtain a mixture of a pigment aggregate in which water permeated. After it was kneaded using a two-roller mill at a roller surface temperature of 130° C. for 45 minutes, and then the mixture was milled to 1 mm in diameter with a pulverizer to obtain “Master Batch 10”.

(Preparation of Dispersion of Pigment and Wax (Oil Phase))

In a vessel with an agitator and a thermometer, 378 parts of “Polyester 10”, 120 parts of paraffin wax (HNP9), and 1450 parts of ethyl acetate were charged. After it was heated up to 80° C. while being agitated and maintained at 80° C. for 5 hours, the mixture was cooled down to 30° C. in one hour. Next, 500 parts of “Master Batch 10” and 500 parts of ethyl acetate were charged in the vessel, which was mixed for one hour to obtain “Raw Material Solution 10”.

In a vessel 1,500 parts of “Raw Material Solution 10” was transferred, and the carbon black and the wax were dispersed in three passes using a bead mill, manufactured by Ultraviscomill by Aimex Co., Ltd. Here, the bead mill was filled with 0.5-mm zirconia beads at 80% by volume, and in each pass “Raw Material Solution 1” was introduced in the bead bill at a liquid feeding rate of 1 kg/hr, and was dispersed at a disk circumferential velocity of 6 m/sec. Next, 655 parts of 65% ethyl acetate solution of “Polyester 10” was added, and the mixture was dispersed in one pass using the bead mill under the same conditions mentioned above to obtain “Pigment-Wax Dispersion 10”. “Pigment-Wax Dispersion 10” was prepared by adding ethyl acetate to be a solid concentration (130° C., 30 minutes) of 50%.

(Preparation of Aqueous Phase)

953 parts of ion exchanged water, 88 parts of a 25 mass % aqueous dispersion of organic resin fine particles for the dispersion stability (styrene-methacrylic acid-sodium salt of butyl acrylate-methacrylic acid ethylene oxide adduct sulfate ester copolymer), 90 parts of a 48.5 mass % aqueous solution of sodium dodecyldiphenyl ether disulfonate (ELEMINOL MON-7, manufactured by Sanyo Chemical Industries, Ltd.), and 113 parts of ethyl acetate were mixed and stirred to obtain a milky white liquid. This was hereinafter referred to as “Aqueous Phase 10”.

(Emulsification)

In this process, 976 parts of “Pigment-Wax Dispersion 10” and 2% (with respect to solid state toner) of the layered inorganic materials in Table 2 were added to the mixture. Next, 6 parts of isophoronediamine as amines were added and mixed by means of T.K. HOMO MIXER manufactured by Tokushu Kika Kogyo Co., Ltd. at 5,000 rpm for 1 minute. After 137 parts of “Prepolymer 10” was added and mixed by means of T.K. HOMO MIXER manufactured by Tokushu Kika Kogyo Co., Ltd. at 5,000 rpm for 1 minute, 1,200 parts of “Aqueous Phase 10” was added and the mixture was mixed by means of T.K. HOMO MIXER while adjusting the rotation speed between 8,000 rpm and 13,000 rpm for 20 minutes to obtain “Emulsified Slurry 10”.

Desolvation

In a vessel equipped with an agitator and a thermometer, “Emulsified Slurry 10” was introduced and desolvated at 30° C. for 8 hours to obtain “Dispersed Slurry 10”.

(Washing and Drying)

After 100 parts of “Dispersed Slurry 10” was filtered under a reduced pressure:

(1) 100 parts of ion-exchanged water was added to the filter cake, mixed using T.K. HOMO MIXER at 12,000 rpm for 10 minutes, and then filtered;

(2) 900 parts of ion-exchanged water was added to the filter cake of (1), mixed using T.K. HOMO MIXER at 12,000 rpm for 30 minutes while applying ultrasonic vibrations and then filtered under a reduced pressure. This operation was repeated until the conductivity of the slurry liquid became 10 μC/cm or less.

(3) 10% hydrochloric acid was added to the slurry liquid of (2) to be pH of 4, agitated by means of Three-One Motor for 30 minutes, and then filtered; and

(4) 100 parts of ion-exchanged water was added to the filter cake of (3), mixed by means of T.K. HOMO MIXER at 12,000 rpm for 10 minutes and then filtered. This operation was repeated until the conductivity of the slurry liquid became 10 μC/cm or less to obtain “Filter Cake 10”.

“Filter Cake 10” was dried at 45° C. for 48 hours in a circulating air dryer, and then, it was passed through a sieve of 75 μm mesh to obtain “Toner Base 10”. “Toner Base 10” had the volume average particle diameter (Dv) of 5.8 μm, the number average particle diameter (Dp) of 5.2 μm, the ratio of Dv to Dp (Dv/Dp) of 1.12, and the average circularity of 0.973. Then, 2.0 parts of hydrophobic silica (NAX50) were added and mixed to 100 parts of “Toner Base” in HENSCHEL MIXER (circumferential velocity of 40 m/sec, 20 seconds) to obtain a “developer 10”.

### Examples 11 to 19 and Comparative Examples 5 and 6

The developers of Examples 11 to 19 and Comparative Examples 5 and 6 were produced in the same manner as in Example 10 except that the types and amounts of external addition of inorganic fine particles and the mixing conditions were changed as shown in Table 2. Table 3 and Table 4 summarize the results from Examples 10 to 19 and Comparative Examples 5 and 6.

TABLE 2

| | Toner composition | | | | | | | | | |
|---|---|---|---|---|---|---|---|---|---|---|
| | Layered | | | | | | | | | |
| | inorganic | | | | | | | | | |
| | materials | | Inorganic fine particles | | | | | | | |
| | | [wt %] with | | | Added | | | Detached ratio of material [%] | | |
| | | respect to | | Particle | amount | Mixing conditions | | Non- | | |
| | | solid state | | diameter | [parts by | Circumferential | Time | transferred | Collecting | |
| | Type | toner | Type | [nm] | mass] | speed [m/s] | [s] | (R1) | unit (R2) | R1:R2 |
| Example 10 | a | 2 | NAX50 | 35 | 2 | 40 | 120 | 10 | 35 | 1:3.5 |
| Example 11 | a | 2 | NAX50 | 35 | 2 | 40 | 120 | 10 | 35 | 1:3.5 |
| Example 12 | a | 2 | NAX50 | 35 | 2 | 40 | 120 | 10 | 35 | 1:3.5 |
| Example 13 | a | 2 | NAX50 | 35 | 2 | 40 | 120 | 10 | 35 | 1:3.5 |
| Example 14 | a | 2 | NAX50 | 35 | 2 | 40 | 120 | 10 | 35 | 1:3.5 |
| Example 15 | a | 2 | NAX50 | 35 | 2 | 40 | 120 | 10 | 35 | 1:3.5 |
| Example 16 | a | 2 | NAX50 | 35 | 2 | 40 | 120 | 10 | 35 | 1:3.5 |
| Example 17 | a | 0.05 | NAX50 | 35 | 2 | 40 | 120 | 10 | 35 | 1:3.5 |
| Example 18 | a | 3 | NAX50 | 35 | 2 | 40 | 120 | 10 | 35 | 1:3.5 |
| Example 19 | a | 0.02 | NAX50 | 35 | 2 | 40 | 120 | 10 | 35 | 1:3.5 |
| Comparative | — | N/A | NAX50 | 35 | 2 | 40 | 300 | 2 | 10 | 1:5 |
| Example 5 | | | | | | | | | | |
| Comparative | b | 2 | NAX50 | 35 | 2 | 40 | 300 | 2 | 10 | 1:5 |
| Example 6 | | | | | | | | | | |

Layered Inorganic Compounds
a: Claytone APA (manufactured by Southern Clay Products, Inc.)
b: Kunipia (unmodified layered inorganic montmorillonite, manufactured by Kunimine Industries Co., Ltd.)

TABLE 3

| | Charge giving unit for recharging toner remaining on the latent | | | | |
|---|---|---|---|---|---|
| | electrostatic image bearing member | | | | |
| | | Sheet thickness | Resistance | Applied voltage | Contact nip width |
| | Material | (mm) | (Ω) | (V) | (mm) |
| Example 10 | PVDF sheet | 0.1 | 10E+3 | −200 | 3 |
| Example 11 | PVDF sheet | 0.5 | 10E+3 | −200 | 3 |
| Example 12 | PVDF sheet | 0.1 | 10E+8 | −200 | 3 |
| Example 13 | PVDF sheet | 0.1 | 10E+3 | −800 | 3 |
| Example 14 | PVDF sheet | 0.1 | 10E+3 | −200 | 8 |
| Example 15 | PVDF roller | — | 10E+3 | −200 | 3 |
| Example 16 | PVDF brush | — | 10E+3 | −200 | 3 |
| Example 17 | PVDF sheet | 0.1 | 10E+3 | −200 | 3 |
| Example 18 | PVDF sheet | 0.1 | 10E+3 | −200 | 3 |
| Example 19 | PVDF sheet | 0.1 | 10E+3 | −200 | 3 |
| Comparative | PVDF sheet | 0.1 | 10E+3 | −200 | 3 |
| Example 5 | | | | | |
| Comparative | PVDF sheet | 0.1 | 10E+3 | −200 | 3 |
| Example 6 | | | | | |

TABLE 4

| | Evaluation results | | | | | | | | | |
|---|---|---|---|---|---|---|---|---|---|---|
| | | | | | | | | | Developing and | |
| | Photoconductor | | Ra | Rb | Rc | | | | collecting property | |
| | filming | Charge | (%) | (%) | (%) | Rb < Rc | Rb/Ra | Rb/Rc | L* | Evaluation |
| Example 10 | A | A | 53 | 9 | 13 | A | 0.17 | 0.69 | 92 | A |
| Example 11 | A | A | 52 | 8 | 12 | A | 0.15 | 0.67 | 93 | A |
| Example 12 | A | A | 50 | 7 | 14 | A | 0.14 | 0.50 | 91 | A |
| Example 13 | A | A | 52 | 10 | 14 | A | 0.19 | 0.71 | 91 | A |
| Example 14 | A | A | 54 | 6 | 13 | A | 0.11 | 0.46 | 91 | A |
| Example 15 | A | A | 52 | 10 | 12 | A | 0.19 | 0.83 | 88 | B |
| Example 16 | A | A | 53 | 10 | 12 | A | 0.19 | 0.83 | 85 | B |
| Example 17 | A | A | 56 | 10 | 15 | A | 0.18 | 0.67 | 86 | B |
| Example 18 | A | A | 49 | 6 | 10 | A | 0.12 | 0.60 | 92 | B |
| Example 19 | A | A | 55 | 11 | 17 | A | 0.20 | 0.65 | 82 | B |
| Comparative | C | A | 56 | 20 | 15 | C | 0.36 | 1.33 | 72 | C |
| Example 5 | | | | | | | | | | |
| Comparative | C | A | 51 | 18 | 15 | C | 0.35 | 1.20 | 76 | C |
| Example 6 | | | | | | | | | | |

### Reference Example 20

### Synthesis of Polyester

(Polyester 20) In a reaction vessel equipped with a cooling tube, an agitator, and a nitrogen introduction tube, 553 parts of bisphenol A ethylene oxide 2 mole adduct, 196 parts of bisphenol A propylene oxide 2 mole adduct, 220 parts of terephthalic acid, 45 parts of adipic acid and 2 parts of dibutyl tin oxide were charged and reacted at a normal pressure and a temperature of 230° C. for 8 hours. After it was further reacted at a reduced pressure of 10 mmHg to 15 mmHg for 5 hours, 46 parts of trimellitic anhydride was added to the reaction vessel. The mixture was reacted at a normal pressure and a temperature of 180° C. for 2 hours to obtain “Polyester 20”. “Polyester 20” had a number-average molecular mass of 2,200, a weight average molecular mass of 5,600, a glass transition temperature (Tg) of 43° C. and an acid value of 13 mg KOH/g.

(Synthesis of Prepolymer)

In a reaction vessel equipped with a cooling tube, an agitator, and a nitrogen introduction tube, 682 parts of bisphenol A ethylene oxide 2 mole adduct, 81 parts of bisphenol A propylene oxide 2 mole adduct, 283 parts of terephthalic acid, 22 parts of trimellitic anhydride and 2 parts of dibutyl tin oxide were charged and reacted at a normal pressure and a temperature of 230° C. for 8 hours. It was further reacted at a reduced pressure of 10 mmHg to 15 mmHg for 5 hours to obtain “Intermediate Polyester 20”. “Intermediate Polyester 20” had a number average molecular mass of 2,100, a weight average molecular mass of 9,500, a glass transition temperature (Tg) of 55° C., an acid value of 0.5 mg KOH/g and a hydroxyl value of 49 mg KOH/g.

Next, in a reaction vessel equipped with a cooling tube, an agitator, and a nitrogen introduction tube, 411 parts of “Intermediate Polyester 20”, 89 parts of isophorone diisocyanate and 500 parts of ethyl acetate were charged and reacted at a temperature of 100° C. for 5 hours to obtain “Prepolymer 20”. “Prepolymer 20” had a free isocyanate content of 1.53% by mass.

(Synthesis of Master Batch)

40 parts of Carbon black (REGAL™ 400R by Cabot corporation), 60 parts of a polyester resin as a binder resin (RS-801 by Sanyo Chemical Industries, Ltd., acid value of 10, Mm of 20,000, Tg of 64° C.), and 30 parts of water were mixed in HENSCHEL MIXER to obtain a mixture of a pigment aggregate in which water permeated. After it was kneaded using a two-roller mill at a roller surface temperature of 130° C. for 45 minutes, and then the mixture was milled to be 1 mm in diameter with a pulverizer to obtain “Master Batch 20”.

(Preparation of Dispersion of Pigment and Wax (Oil Phase))

In a vessel with an agitator and a thermometer, 378 parts of “Polyester 20”, 120 parts of paraffin wax (HNP9), and 1450 parts of ethyl acetate were charged. After it was heated up to 80° C. while being agitated and maintained at 80° C. for 5 hours, the mixture was cooled down to 30° C. in one hour. Next, 500 parts of “Master Batch 20” and 500 parts of ethyl acetate were charged in the vessel, which was mixed for one hour to obtain “Raw Material Solution 20”.

In a vessel 1,500 parts of “Raw Material Solution 20” was transferred, and the carbon black and the wax were dispersed in three passes using a bead mill, manufactured by Ultraviscomill by Aimex Co., Ltd. Here, the bead mill was filled with 0.5-mm zirconia beads at 80% by volume, and in each pass “Raw Material Solution 1” was introduced in the bead bill at a liquid feeding rate of 1 kg/hr, and was dispersed at a disk circumferential velocity of 6 m/sec. Next, 655 parts of 65% ethyl acetate solution of “Polyester 20” was added, and the mixture was dispersed in one pass using the bead mill under the same conditions mentioned above to obtain “Pigment-Wax Dispersion 20”. “Pigment-Wax Dispersion 20” was prepared by adding ethyl acetate to be a solid concentration (130° C., 30 minutes) of 50%.

(Preparation of Aqueous Phase)

953 parts of ion exchanged water, 88 parts of a 25 mass % aqueous dispersion of organic resin fine particles for the dispersion stability (styrene-methacrylic acid-sodium salt of butyl acrylate-methacrylic acid ethylene oxide adduct sulfate ester copolymer), 90 parts of a 48.5 mass % aqueous solution of sodium dodecyldiphenyl ether disulfonate (ELEMINOL MON-7, manufactured by Sanyo Chemical Industries, Ltd.), and 113 parts of ethyl acetate were mixed and stirred to obtain a milky white liquid. This was hereinafter referred to as “Aqueous Phase 20”.

(Emulsification)

In this process, 967 parts of “Pigment-wax dispersion 20” and 2% (with respect to solid state toner) of the layered inorganic materials in Table 5 were added to the mixture. Next, 6 parts of isophoronediamine as amines were added and mixed by means of T.K. HOMO MIXER manufactured by Tokushu Kika Kogyo Co., Ltd.) at 5,000 rpm for 1 minute. After 137 parts of the “prepolymer 20” were added, and mixed by means of T.K. HOMO MIXER manufactured by Tokushu Kika Kogyo Co., Ltd at 5,000 rpm for 1 minute, 1,200 parts of the “aqueous phase 20” were added and the mixture was mixed for 20 minutes by means of T.K. HOMO MIXER while adjusting the rotation speed between 8,000 rpm and 13,000 rpm to obtain the “emulsion slurry 20”.

(Desolvation)

In a vessel equipped with an agitator and a thermometer, “Emulsified Slurry 20” was introduced and desolvated at 30° C. for 8 hours to obtain “Dispersed Slurry 20”.

(Washing and Drying)

After 100 parts of “Dispersed Slurry 20” was filtered under a reduced pressure:

(1) 100 parts of ion-exchanged water was added to the filter cake, mixed using T.K. HOMO MIXER at 12,000 rpm for 10 minutes, and then filtered;

(2) 900 parts of ion-exchanged water was added to the filter cake of (1), mixed using T.K. HOMO MIXER at 12,000 rpm for 30 minutes while applying ultrasonic vibrations and then filtered under a reduced pressure. This operation was repeated until the conductivity of the slurry liquid became 10 μC/cm or less;

(3) 10% hydrochloric acid was added to the slurry liquid of (2) to be pH of 4, agitated by means of Three-One Motor for 30 minutes, and then filtered; and

(4) 100 parts of ion-exchanged water was added to the filter cake of (3), mixed by means of T.K. HOMO MIXER at 12,000 rpm for 10 minutes and then filtered. This operation was repeated until the conductivity of the slurry liquid became 10 μC/cm or less to obtain “Filter Cake 20”.

“Filter Cake 20” was dried at 45° C. for 48 hours in a circulating air dryer, and then, it was passed through a sieve of 75 μm mesh to obtain “Toner Base 20”. “Toner Base 20” had the volume average particle diameter (Dv) of 5.8 μm, the number average particle diameter (Dp) of 5.2 μm, the ratio of Dv to Dp (Dv/Dp) of 1.12, and the average circularity of 0.973. Then, 0.5 parts of hydrophobic silica and 0.5 parts of hydrophobized titanium oxide were added and mixed to 100 parts of “Toner Base” in HENSCHEL MIXER to obtain a “developer 20”.

### Reference Examples 21 to 29

The developers of Reference Examples 21 to 29 were produced in the same manner as in Reference Example 20 except that the types and added amounts of the layered inorganic materials were changed as shown in Table 5.

### Reference Example 30

### Preparation of Colorant Dispersion 30

125 parts of Carbon Black (Printex 35: manufactured by Daicel-Degussa, Ltd.), 18.8 parts of Ajisper (manufactured by Ajinomoto Fine Techno Co., Ltd.), and 356.2 parts of ethyl acetate (high grade ethyl acetate manufactured by Wako Pure Chemical Industries, Ltd.) were dissolved/dispersed using an Ultra Visco Mill (manufactured by Aimex Co., Ltd.), to prepare the [colorant dispersion 30], which includes a dispersed colorant (black pigment).

(Preparation of Releasing Agent Dispersion (Wax Component A))

A [releasing agent dispersion 30] was prepared by wet pulverization of 30 parts of carnauba wax (melting point 83° C., acid value 8 mg KOH/g, saponification value 80 mg KOH/g) and 270 parts of ethyl acetate (high grade ethyl acetate manufactured by Wako Pure Chemical Industries, Ltd.) using an Ultra Visco Mill (manufactured by Aimex Co., Ltd.).

(Preparation of Organic Cation-Modified Layered Inorganic Material Dispersion 30)

A [layered inorganic material dispersion 30] was prepared by wet pulverization of 30 parts of Claytone APA (manufactured by Southern Clay Products, Inc.) and 270 parts of ethyl acetate (high grade ethyl acetate manufactured by Wako Pure Chemical Industries, Ltd.) using an Ultra Visco Mill (manufactured by Aimex Co., Ltd.).

(Preparation of Liquid A)

A [liquid A] was prepared by mixing 350 parts of polyester resin (Mw=50,000, Mn=3,000, acid value=15 mg KOH/g, hydroxyl value=27 mg KOH/g, Tg=55° C., softening point=112° C.) made up of bisphenol-A propylene oxide adduct, bisphenol-A ethylene oxide adduct, and terephthalic acid derivatives, 245 parts of the [colorant dispersion 30], 800 parts of [releasing agent dispersion 30], 400 parts of [layered inorganic material dispersion 30], and 17.8 parts of the hydrophobic silicon oxide fine particles (R972 manufactured by Aeorsil). The mixture was then stirred until to be uniform to obtain [liquid A].

(Preparation of Liquid B)

A [liquid B] was prepared by stirring 100 parts of calcium carbonate dispersion including 40 parts of fine calcium carbonate particles dispersed in 60 parts of water and 200 parts of 1% aqueous solution of Serogen BS-H (manufactured by Dai-Ichi Kogyo Seiyaku Co., Ltd.) and 157 parts of water for 3 minutes using a T.K. HOMO DISPER f-model (manufactured by Primix Corporation).

(Preparation of Toner)

After preparing a suspension by stirring 345 parts of the liquid B with 250 parts of the liquid A using a T.K. HOMO MIXER mark 2 f-model (manufactured by Primix Corporation) for 2 minutes at 10,000 rpm, the solvent was removed by stirring at room temperature and atmospheric pressure for 48 hours using a propeller type stirrer. After removing the calcium carbonate by adding hydrochloric acid, the product was washed, dried, and graded to yield the toner. The average toner particle diameter was 6.2 μm.

### Reference Example 31

After introducing 5 parts of Na₃PO₄ to 500 parts of ion-exchanged water and heating to 60° C., the mixture was stirred using a CLEARMIX high speed stirrer (manufactured by M-Technique Co., Ltd., rotation speed 22 m/s). A solution of 2 parts of CaCl₂ dissolved in 15 parts of ion exchanged water was added without delay to this mixture to obtain an aqueous dispersion medium that includes Ca₃(PO₄)₂.

In addition, 85 parts of polymerizable styrene monomer, 20 parts of n-butyl acrylate, 7.5 parts of C.I. Pigment Blue 15:3 colorant, 1 part of E-88 charge controlling agent (manufactured by Orient Chemical Industries, Ltd.), 5 parts of unsaturated polyester polar resin (acid value 10 mgKOH/g, peak molecular weight: 7,500), 15 parts of ester wax releasing agent (largest DSC endothermic peak temperature of 72° C.), and 2 parts of Claytone APA (manufactured by Southern Clay Products, Inc.) were heated to 60° C., stirred, and uniformly dissolved or dispersed in a polymerizable monomer. A polymerizable monomer composition was prepared by adding 3 parts of 2,2′-azobis(2,4-dimethylvaleronitrile) as a polymerization initiator to this mixture.

The polymerizable monomer composition was introduced to the aqueous dispersion medium, and the mixture was then stirred for 15 minutes at 60° C. under N₂ atmosphere using a CLEARMIX high speed stirrer (manufactured by M-Technique Co., Ltd., rotation speed 22 m/s), thereby generating polymerizable monomer composition particles in the aqueous medium. After dispersion, the stirrer was stopped, and the preparation was introduced to a polymerization device equipped with a FULLZONE blade (manufactured by Shinko Pantec Co., Ltd.). In the polymerization device 11, the polymerizable monomer preparation was allowed to react for 5 hours at 60° C. in an N₂ atmosphere while being stirred by a mixing blade with a maximum tip speed of 3 m/s. The temperature was then raised to 80° C., and the polymerizable monomer preparation was allowed to react for a further 5 hours. On completion of the polymerization reaction, the product was washed, dried, and graded to yield the toner. The average toner particle diameter was 6.8 μm.

### Comparative Examples 7 to 9

The developers of Comparative Examples 7 to 9 were produced in the same way as in Reference Example 20 except that the types and added amounts of the layered inorganic materials were changed as shown in Table 5.

The material characteristics of the highly polar resin prepared in the manner described above are summarized in the prepared resin section of Table 5 and the results and characteristics of the developers prepared in Reference Examples 20 to 31 and in Comparative Examples 7 to 9 are summarized in the toner evaluation section of Table 5.

TABLE 5
Reference Examples and Comparative Examples

| | Toner composition | | | | | | | | | | |
|---|---|---|---|---|---|---|---|---|---|---|---|
| | Layered inorganic | | | | | | | | | | |
| | materials | | | | | | | | | | |
| | | Concentration | Charge giving unit for recharging toner remaining on the | | | | | | | | |
| | | (wt %) (with | latent electrostatic image bearing member | | | | | Evaluation results | | | |
| | | respect to | | Sheet | | Applied | Contact | Initial period | | | |
| | | solid state | | thickness | Resistance | voltage | nip width | Ra | Rb | Rc | |
| | Type | toner) | Material | (mm) | (Ω) | (V) | (mm) | (%) | (%) | (%) | Rb < Rc |
| Ref. Ex. 20 | a | 2 | PVDF sheet | 0.1 | 10E+3 | −200 | 3 | 53 | 9 | 13 | A |
| Ref. Ex. 21 | a | 2 | PVDF sheet | 0.5 | 10E+3 | −200 | 3 | 52 | 8 | 12 | A |
| Ref. Ex. 22 | a | 2 | PVDF sheet | 0.1 | 10E+8 | −200 | 3 | 50 | 7 | 14 | A |
| Ref. Ex. 23 | a | 2 | PVDF sheet | 0.1 | 10E+3 | −800 | 3 | 52 | 10 | 14 | A |
| Ref. Ex. 24 | a | 2 | PVDF sheet | 0.1 | 10E+3 | −200 | 8 | 54 | 6 | 13 | A |
| Ref. Ex. 25 | a | 2 | PVDF roller | — | 10E+3 | −200 | 3 | 52 | 10 | 12 | A |
| Ref. Ex. 26 | a | 2 | PVDF brush | — | 10E+3 | −200 | 3 | 53 | 10 | 12 | A |
| Ref. Ex. 27 | a | 0.05 | PVDF sheet | 0.1 | 10E+3 | −200 | 3 | 56 | 10 | 15 | A |
| Ref. Ex. 28 | a | 3 | PVDF sheet | 0.1 | 10E+3 | −200 | 3 | 49 | 6 | 10 | A |
| Ref. Ex. 29 | a | 0.02 | PVDF sheet | 0.1 | 10E+3 | −200 | 3 | 55 | 11 | 17 | A |
| Ref. Ex. 30 | a | 1 | PVDF sheet | 0.1 | 10E+3 | −200 | 3 | 56 | 10 | 12 | A |
| Ref. Ex. 31 | a | 1.5 | PVDF sheet | 0.1 | 10E+3 | −200 | 3 | 52 | 10 | 16 | A |
| Comp. Ex. 7 | — | N/A | PVDF sheet | 0.1 | 10E+3 | −200 | 3 | 56 | 20 | 15 | C |
| Comp. Ex. 8 | b | 2 | PVDF sheet | 0.1 | 10E+3 | −200 | 3 | 51 | 18 | 15 | C |
| Comp. Ex. 9 | a | 2 | N/A | — | — | — | — | 51 | 51 | 15 | C |

| | Evaluation results | | | | | | | | | |
|---|---|---|---|---|---|---|---|---|---|---|
| | Initial period | | | | | | | | | |
| | | | Developing and | | After printing 1000 Sheets | | | | | |
| | Rb/ | Rb/ | collecting property | | Ra | Rb | Rc | | Rb/ | Rb/ |
| | Ra | Rc | L* | Evaluation | (%) | (%) | (%) | Rb < Rc | Ra | Rc |
| Ref. Ex. 20 | 0.17 | 0.69 | 92 | AA | 60 | 11 | 15 | A | 0.18 | 0.73 |
| Ref. Ex. 21 | 0.15 | 0.67 | 93 | AA | 59 | 10 | 13 | A | 0.17 | 0.77 |
| Ref. Ex. 22 | 0.14 | 0.50 | 91 | AA | 58 | 10 | 14 | A | 0.17 | 0.71 |
| Ref. Ex. 23 | 0.19 | 0.71 | 91 | AA | 61 | 11 | 16 | A | 0.18 | 0.69 |
| Ref. Ex. 24 | 0.11 | 0.46 | 91 | AA | 62 | 11 | 18 | A | 0.18 | 0.61 |
| Ref. Ex. 25 | 0.19 | 0.83 | 88 | A | 60 | 10 | 15 | A | 0.17 | 0.67 |
| Ref. Ex. 26 | 0.19 | 0.83 | 85 | A | 62 | 12 | 18 | A | 0.19 | 0.67 |
| Ref. Ex. 27 | 0.18 | 0.67 | 86 | A | 63 | 10 | 15 | A | 0.16 | 0.67 |
| Ref. Ex. 28 | 0.12 | 0.60 | 92 | A | 59 | 9 | 10 | A | 0.15 | 0.90 |
| Ref. Ex. 29 | 0.20 | 0.65 | 82 | B | 67 | 13 | 20 | A | 0.19 | 0.65 |
| Ref. Ex. 30 | 0.18 | 0.83 | 88 | A | 63 | 11 | 15 | A | 0.17 | 0.73 |
| Ref. Ex. 31 | 0.19 | 0.63 | 90 | AA | 60 | 11 | 18 | A | 0.18 | 0.61 |
| Comp. Ex. 7 | 0.36 | 1.33 | 72 | C | 70 | 27 | 22 | C | 0.39 | 1.23 |
| Comp. Ex. 8 | 0.35 | 1.20 | 76 | C | 67 | 20 | 17 | C | 0.30 | 1.18 |
| Comp. Ex. 9 | 1.00 | 3.40 | 70 | C | 60 | 61 | 17 | C | 1.02 | 3.59 |

Layered Inorganic Compounds
a: Claytone APA (manufactured by Southern Clay Products, Inc.)
b: Kunipia (unmodified layered inorganic montmorillonite, manufactured by Kunimine Industries Co., Ltd.)

What is claimed is:

1. An image forming apparatus comprising:
a latent electrostatic image bearing member for bearing thereon an image;
a charging unit configured to uniformly charge a surface of the latent electrostatic image bearing member;
a latent electrostatic image forming unit configured to form a latent electrostatic image on the latent electrostatic image bearing member;
a developing unit configured to supply toner and develop the latent electrostatic image on the latent electrostatic image bearing member;
a transfer unit configured to transfer a toner image formed on the latent electrostatic image bearing member to a transfer member; and
a collecting unit configured to collect non-transferred toner remaining on the latent electrostatic image bearing member after transfer,
wherein the non-transferred toner collected by the collecting unit is supplied to the developing unit for reuse, and
wherein the toner has inorganic fine particles externally added thereto,
a detached ratio R1 of the inorganic fine particles from the non-transferred toner is from 0% to 20%,
a detached ratio R2 of the inorganic fine particles from toner passed through the collecting unit is from 20% to 80%,
and a ratio of the detached ratio R2 to the detached ratio R1, R2/R1, is 1.5 or more.

2. The image forming apparatus according to claim 1, wherein the charging unit functions as the collecting unit.

3. The image forming apparatus according to claim 1, further comprising
a charge giving unit configured to recharge toner remaining on the surface of the latent electrostatic image bearing member after transfer,
wherein Ra, Rb and Rc satisfy the relationship Rb<Rc and Rb/Ra<0.2, where Ra is the amount of oppositely charged toner after transfer and before passing the charging unit, Rb is the amount of oppositely charged toner after passing the charging unit and before passing the developing unit, and Rc is the amount of oppositely charged toner before transfer and after passing the developing unit.

4. The image forming apparatus according to claim 3, wherein Rb and Rc satisfy the relationship Rb/Rc≦1.

5. The image forming apparatus according to claim 3, wherein
the charge giving unit is a conductive sheet that contacts the surface of the latent electrostatic image bearing member by pressure.

6. The image forming apparatus according to claim 1, wherein the toner is prepared using an aqueous medium.

7. The image forming apparatus according to claim 1, wherein
a toner composition constituting the toner contains at least a pigment, a binder resin, and a layered inorganic material in which at least a portion of ions between layers is modified with organic ions, and wherein
the image forming apparatus uses the toner prepared by dispersing and/or emulsifying in an aqueous medium at least one of an oil phase and a monomer phase, the oil phase including at least one of the toner composition and a precursor of the toner composition.

8. The image forming apparatus according to claim 1, wherein
the latent electrostatic image bearing member is an organic photoconductor.

9. The image forming apparatus according to claim 1, wherein
a cover ratio of the toner surface by the inorganic fine particles in the developing unit is from 50% to 200%.

10. The image forming apparatus of claim 1, wherein
the inorganic fine particles have a volume average particle diameter of 5 nm to 200 nm.

11. The image forming apparatus according to claim 1, wherein
the toner has an average circularity of 0.95 to 0.99 and a volume average particle diameter of 4 μm to 8 μm.

12. The image forming apparatus according to claim 1, further comprising a fixing unit that uses a roller equipped with a heating device.

13. The image forming apparatus according to claim 1, further comprising a fixing unit that uses a belt equipped with a heating device.

14. The image forming apparatus according to claim 1, further comprising an oil-less fixing unit having a fixing member for which an oil coating is unnecessary.

15. The image forming apparatus according to claim 1, wherein the toner is a non-magnetic one component development-use toner.

16. The image forming apparatus according to claim 5, wherein the conductive sheet is formed from one selected from nylon, PTFE, PVDF and urethane.

17. The image forming apparatus according to claim 5, wherein the conductive sheet has a thickness of 0.05 mm to 0.5 mm.

18. The image forming apparatus according claim 5, wherein the conductive sheet has a resistance of 10Ω to 10⁹Ω.

19. The image forming apparatus according to claim 5, wherein a voltage applied to the conductive sheet is from −1.4 kV to 0 kV.

20. The image forming apparatus according to claim 5, wherein a nip width of a contact between the conductive sheet and the latent electrostatic image bearing member is from 1 mm to 10 mm.

21. The image forming apparatus according to claim 7, wherein the layered inorganic materials are layered inorganic materials in which at least part of cation that exists between layers of the layered inorganic materials is modified with organic cation.

22. The image forming apparatus according to claim 7, wherein the layered inorganic material constitutes 0.05% by mass to 2% by mass of the solid of at least one selected from the oil phase and the monomer phase.

23. The image forming apparatus according to claim 7, wherein the toner has an acid value of 0.5 KOHmg/g to 40.0 KOHmg/g.

24. A toner for use in an image forming method by which non-transferred toner is temporarily collected and supplied for reuse in an image forming apparatus that includes:
a latent electrostatic image bearing member for bearing thereon an image;
a charging unit configured to uniformly charge a surface of the latent electrostatic image bearing member;
a latent electrostatic image forming unit configured to form a latent electrostatic image on the latent electrostatic image bearing member;
a developing unit configured to supply toner and develop the latent electrostatic image on the latent electrostatic image bearing member;
a transfer unit configured to transfer a toner image formed on the latent electrostatic image bearing member to a transfer member; and
a collecting unit configured to collect non-transferred toner remaining on the latent electrostatic image bearing member after transfer,
wherein the non-transferred toner collected by the collecting unit is supplied to the developing unit for reuse, and
wherein the toner has inorganic fine particles externally added thereto,
a detached ratio R1 of the inorganic fine particles from the non-transferred toner is from 0% to 20%,
a detached ratio R2 of the inorganic fine particles from toner passed through the collecting unit is from 20% to 80%,
and a ratio of the detached ratio R2 to the detached ratio R1, R2/R1, is 1.5 or more.

25. An image forming method comprising:
using an image forming apparatus including a latent electrostatic image bearing member for bearing thereon an image, a charging unit configured to uniformly charge a surface of the latent electrostatic image bearing member, a latent electrostatic image forming unit configured to form a latent electrostatic image on the latent electrostatic image bearing member, a developing unit configured to supply toner and develop the latent electrostatic image on the latent electrostatic image bearing member, a transfer unit configured to transfer a toner image formed on the latent electrostatic image bearing member to a transfer member, and a collecting unit configured to collect non-transferred toner remaining on the latent electrostatic image bearing member after transfer,
wherein the non-transferred toner collected by the collecting unit is supplied to the developing unit for reuse, and
wherein the toner has inorganic fine particles externally added thereto,
a detached ratio R1 of the inorganic fine particles from the non-transferred toner is from 0% to 20%,
a detached ratio R2 of the inorganic fine particles from toner passed through the collecting unit is from 20% to 80%,
and a ratio of the detached ratio R2 to the detached ratio R1, R2/R1, is 1.5 or more.
